(19) United States
(12) Patent Application Publication
(10) Pub. No.: US 2025/0123466 A1
(43) Pub. Date: Apr. 17, 2025

(54) HYBRID LENS AND OPTICAL SYSTEM

(71) Applicant: SHENZHEN METALENX TECHNOLOGY CO.,LTD, Shenzhen (CN)

(72) Inventors: Chenglong HAO, Shenzhen (CN); Fengze TAN, Shenzhen (CN); Rui ZHU, Shenzhen (CN); Jian ZHU, Shenzhen (CN)

(73) Assignee: SHENZHEN METALENX TECHNOLOGY CO.,LTD, Shenzhen (CN)

(21) Appl. No.: 18/991,669

(22) Filed: Dec. 22, 2024

Related U.S. Application Data
(63) Continuation of application No. PCT/CN2023/097230, filed on May 30, 2023.

(30) Foreign Application Priority Data
Jun. 24, 2022 (CN) 202210726528.1
Jun. 24, 2022 (CN) 202221597882.0

(51) Int. Cl. G02B 13/00; B82Y 20/00; G02B 1/00; G02B 9/60

(52) U.S. Cl. CPC G02B 13/0045; B82Y 20/00; G02B 1/002; G02B 9/60

(57) ABSTRACT

A hybrid lens and an optical system are provided, and the hybrid lens includes a first lens and a second lens in order from an object side to an image side; the first lens is a refractive lens with a positive focal length; the second lens is a metalens; both the object-side surface and the image-side surface of the first lens are aspheric surfaces; the first lens and the second lens further satisfy the conditions:

$${t}_{12} \leq 0.5 mm ; \vert \frac{{f}_{2}}{{f}_{1}} \vert \geq 8 ; {R}_{1 i} > {R}_{1 O} .$$

### CROSS-REFERENCE TO RELATED APPLICATION

This application is a continuation of International Patent Application of PCT application serial No. PCT/CN2023/097230, filed on May 30, 2023, which claims the benefit of priority from China Application No. 202221597882.0 and 202210726528.1, filed on Jun. 24, 2022. The entirety of each of the above-mentioned patent applications is hereby incorporated by reference herein and made a part of this specification.

### BACKGROUND

### Technical Field

The present disclosure relates to a field of metalens, in particular to a hybrid lens and an optical system.

### Description of Related Art

With the improvement of technology, the miniaturization and lightweight of electronic device are getting more and more important, which mean that in the proceeding of the miniaturization of electronic devices, the miniaturization and lightweight of the optical are very important.

However, with the increasing of requirements of imaging performance for users, improving imaging performance needs to increase the number of lenses, which will inevitably increase the TTL (total track length) of the optical system and is not beneficial for the miniaturization and lightweight of the optical system.

Therefore, there is an urgent need to realize the miniaturization and lightweight of the optical system while ensuring the imaging quality.

### SUMMARY

In order to solve the above technical problem that the miniaturization of the optical system is limited by the number of lenses and the volume of the lens, a hybrid lens, an optical system, an imaging device and an electronic device are provided according to the present application.

In the first aspect, a hybrid lens is provided, the hybrid lens including a first lens and a second lens in order from an object side to an image side;

Wherein, the first lens is a refractive lens with a positive focal length; the second lens is a metalens;
each of the first lens and the second lens comprises an object-side surface facing towards the object plane and an image-side surface facing towards the image plane;
both the object-side surface and the image-side surface of the first lens are aspheric surfaces;
the first lens and the second lens further satisfy the conditions:

$${t}_{12} \leq 0.5 mm ;$$

$$\vert \frac{{f}_{2}}{{f}_{1}} \vert \geq 8 ;$$

$${R}_{1 i} > {R}_{1 O} ;$$

wherein, t₁₂ is a distance between the first lens and the second lens; f₁ is a focal length of the first lens; f₂ is a focal length of the second lens; R₁ᵢ is a curvature radius of the image-side surface of the first lens; R₁ₒ is a curvature radius of the object-side surface of the first lens.

In one embodiment, the second lens includes a substrate and at least one nanostructured layers;
each of the nanostructured layers comprises a plurality of nanostructures;
the plurality of nanostructures are arranged in an array.

In one embodiment, a period of the nanostructures in any nanostructured layers is greater than or equal to 0.3λ_{c}, and is less than or equal to 2λ_{c};
wherein, λ_{c} is a central wavelength of the second lens at a working waveband.

In one embodiment, a height of the nanostructures in any nanostructured layer is greater than or equal to 0.3λ_{c}, and is less than or equal to 5λ_{c};
wherein, λ_{c} is a central wavelength of the second lens at a working waveband.

In one embodiment, the at least one nanostructured layer includes a plurality of unit cells, and the plurality of unit cells are arranged in an array;
each unit cell is a dense packing pattern, and the nanostructures are set on a vertice and a center of the dense packing pattern.

In one embodiment, the plurality of nanostructures are polarization-independent structures.

In one embodiment, the polarization-independent structures include cylinder structures, hollow structures, cylindrical structures, round-hole structures, hollow-round-hole structures, square column structures, square hole structures, hollow square column structures and hollow square hole structures.

In one embodiment, the metalens further comprises an antireflection film;
the antireflection film is set on at least one side of the substrate.

In one embodiment, a wide-spectrum phase of unit cell of the second lens also satisfies:

$$- \frac{69 rad}{μm} \leq \frac{d φ ( r = {r}_{0} , λ )}{d λ} \leq - 5 rad / μm ;$$

r is a radial coordinates of the metalens; r₀ is a distance between any position on the metalens and the center of the metalens; λ is a working wavelength of the metalens.

In one embodiment, the plurality of nanostructures in any two adjacent nanostructured layers are coaxial.

In one embodiment, the metalens includes at least two nanostructured layers; the nanostructures in any adjacent nanostructured layer are non-coaxial along a direction parallel with the substrate.

In the second aspect, a manufacturing method for a metalens is provided, wherein the manufacturing method is used to manufacture the metalens of the hybrid lens, and the manufacturing method includes:
S1. setting a structural material layer on the substrate;
S2. coating a photo-resist on the structural material layer, and exposing and obtaining a reference structure;
S3. etching the structural material layer into the nanostructures arranged in period according to the reference structure, so as to form the nanostructured layer;
S4. filling a filler material between the nanostructures;
S5. polishing a surface of the filler material, so as to make the surface of the filler material align with the surface of the nanostructures.

In one embodiment, the manufacturing method further includes:
S6. repeating S1 to S5, until completing all the nanostructured layers.

In the third aspect, an optical system is provided, and the optical system includes five optical elements, wherein in order from an object side to an image side, the five optical elements include: an aperture slot, a hybrid lens, a third lens, a fourth lens and a fifth lens;
each of five optical elements includes an object-side surface facing towards the object plane and an image-side surface facing towards the image plane;
wherein the third lens is an aspheric refractive lens, and a curvature radius of the object-side surface of the third lens is negative;
the fourth lens is a refractive lens, and the object-side surface of the fourth lens is a concave surface;
the fifth lens is a refractive lens, and the object-side surface of the fifth lens is a concave surface;
and there is at least one aspheric surface in the object-side and image-side surfaces of the third lens, the fourth lens and the fifth lens, and the aspheric surface has one point of inflection;
the optical system satisfies the formulas as follows:

$$f / EPD < 3 ;$$

$$25 ° \leq HFOV \leq 55 ° ;$$

$$0.05 mm \leq {d}_{2} \leq 2 mm ;$$

wherein, f is a focal length of the optical system; EPD is an entrance pupil diameter of the optical system; HFOV is a half of the maximum field of view; d₂ is a thickness of the second lens.

In one embodiment, the optical system satisfies the following condition:

$$0.2 \leq {R}_{1 o} / {f}_{1} \leq 0.8 ;$$

wherein R₁ₒ is a curvature radius of the object-side surface of the first lens; f₁ is a focal length of the first lens.

In one embodiment, the optical system satisfies the following condition:

$$( {V}_{1} + {V}_{4} ) / 2 - {V}_{3} > 20 ;$$

wherein, V₁ is an Abbe number of the first lens; V₃ is an Abbe number of the third lens; V₄ is an Abbe number of the fourth lens.

In one embodiment, the optical system satisfies the following condition:

$$1.2 < TTL / ImgH < 1.8 ;$$

wherein TTL is a total track length of the optical system; ImgH is a maximum imaging height of the optical system.

In one embodiment, the optical system further satisfies:

$$\frac{{f}_{2}}{f} > 10 ;$$

wherein f₂ is a focal length of the second lens in the optical system; f is a focal length of the optical system.

In the fourth aspect, an imaging device is provided, wherein the imaging device includes the optical system and an image sensor; the image sensor is set on the image plane of the optical system.

In the fifth aspect, an electronic device is provided, wherein the electronic device includes the imaging device.

In conclusion, the hybrid lens improves the design freedom of the optical system by combining the metalens and the refractive lens. The manufacturing method of metalens manufactures each nanostructured layer of the metalens and obtains the metalens with at least one nanostructured, which increases the aspect ratio of the metalens and improves the design freedom of the metalens. The focal length of the optical system provided by the present application is greater than 3 mm and the TTL of the optical system is less than 3 mm by using the metalens and the refractive lens in the hybrid lens as the first lens and the second lens in the optical system, which realizes the miniaturization and lightweight of the optical system.

### BRIEF DESCRIPTION OF THE DRAWINGS

The above and other targets, features and advantages of the example embodiment thereof by reference to the accompanying drawings.

FIG. 1 shows an optional structural schematic diagram of the hybrid lens provided by the embodiment of the present application;

FIG. 2 shows another optional structural schematic diagram of the metalens provided by the embodiment of the present application;

FIG. 3 shows another optional structural schematic diagram of the metalens provided by the embodiment of the present application;

FIG. 4 shows another optional structural schematic diagram of the metalens provided by the embodiment of the present application;

FIG. 5 shows another optional arrangement diagram of the nanostructures of the metalens provided by the embodiment of the present application;

FIG. 6 shows another optional arrangement diagram of the nanostructures of the metalens provided by the embodiment of the present application;

FIG. 7 shows another optional arrangement diagram of the nanostructures of the metalens provided by the embodiment of the present application;

FIG. 8 shows another optional structural schematic diagram of the nanostructures of metalens provided by the embodiment of the present application;

FIG. 9 shows another optional structural schematic diagram of the nanostructures of metalens provided by the embodiment of the present application;

FIG. 10 shows an optional structural diagram of nanostructures of the metalens provided by the embodiment of the present application;

FIG. 11 shows another optional structural diagram of the metalens provided by the embodiment of the present application;

FIG. 12 shows another optional structural diagram of the metalens provided by the embodiment of the present application;

FIG. 13 shows another optional structural diagram of the metalens provided by the embodiment of the present application;

FIG. 14 shows an optional phase diagram of the metalens provided by the embodiment of the present application;

FIG. 15 shows another optional transmittance diagram of the metalens provided by the embodiment of the present application;

FIG. 16 shows another optional phase diagram of the metalens provided by the embodiment of the present application;

FIG. 17 shows another optional transmittance diagram of the metalens provided by the embodiment of the present application;

FIG. 18 shows an optional flow chart of the manufacturing method of metalens provided in the embodiment of the present application;

FIG. 19 shows another optional flow chart of the manufacturing method of metalens provided in the embodiment of the present application;

FIG. 20 shows another optional flow chart of the manufacturing method of metalens provided in the embodiment of the present application;

FIG. 21 shows an optional structural diagram of the optical system provided by the present application;

FIG. 22 shows a schematic diagram of phase modulation of the second lens at different wavelengths in the optical system;

FIG. 23 shows an astigmatism diagram of the optical system;

FIG. 24 shows a distortion diagram of the optical system;

FIG. 25 shows an optional MTF diagram of the optical system provided by the present application;

FIG. 26 shows a matching degree of the wide spectrum of the second lens in the optical system;

FIG. 27 shows an optional structural diagram of the optical system provided by the present application;

FIG. 28 shows a schematic diagram of phase modulation of the second lens at different wavelengths in the optical system;

FIG. 29 shows an astigmatism diagram of the optical system;

FIG. 30 shows a distortion diagram of the optical system;

FIG. 31 shows an optional MTF diagram of the optical system provided by the present application;

FIG. 32 shows a matching degree of the wide spectrum of the second lens in the optical system;

FIG. 33 shows an optional structural diagram of the optical system provided by the present application;

FIG. 34 shows a schematic diagram of phase modulation of the second lens at different wavelengths in the optical system;

FIG. 35 shows an astigmatism diagram of the optical system;

FIG. 36 shows a distortion diagram of the optical system;

FIG. 37 shows an optional MTF diagram of the optical system provided by the present application;

FIG. 38 shows a matching degree of the wide spectrum of the second lens in the optical system;

FIG. 39 shows an optional structural diagram of the optical system provided by the present application;

FIG. 40 shows a schematic diagram of phase modulation of the second lens at different wavelengths in the optical system;

FIG. 41 shows an astigmatism diagram of the optical system;

FIG. 42 shows a distortion diagram of the optical system;

FIG. 43 shows an optional MTF diagram of the optical system provided by the present application;

FIG. 44 shows a matching degree of the wide spectrum of the second lens in the optical system.

### DESCRIPTION OF THE EMBODIMENTS

The application is more comprehensively described below with reference to the drawings, and the embodiments are shown in the drawings. However, the present application may be implemented in many different ways and should not be construed as limited to the embodiment described herein. Instead, these embodiments are provided such that the application will be exhaustive and complete, and will fully communicate the scope of the application to those skilled in the art. The same attached drawing marks throughout indicate the same components. Furthermore, in the drawings, the thickness, ratio and size of the components are enlarged to clearly illustrate.

The term used herein is used only for the purpose of describing the specific embodiment and is not intended to be a limitation. The “one”, “a single”, “the”, “this”, “one” and “at least” used in this application do not represent a limitation on quantity, but are intended to include both singular and plural. For example, “one part” has the same meaning as “at least one part” unless the context clearly indicates otherwise. “At least one” should not be interpreted as limiting to the quantity “one”. “Or” means “and/or”. The term “and/or” includes any and all combinations of one or more of the associated listed items.

Unless otherwise limited, all terms used herein, including technical and scientific terms, have the same meaning as commonly understood by those skilled in the field. The terms defined in a jointly used dictionary shall be construed to have the same meaning as those defined in the relevant technical context, and are not interpreted in an idealized or too formal meaning, unless clearly defined in the specification.

The meaning of “include” or “comprise” specifies the nature, quantity, steps, operation, parts, parts, or combinations thereof, but does not exclude other nature, quantity, steps, operation, parts, parts, or a combination of them.

This application describes the implementation with a reference to the section diagram as an idealized embodiment. Thus, relative to illustrated shape changes as a result of, for example, manufacturing technique and/or tolerance. Therefore, the embodiments described herein should not be interpreted to be limited to specific shapes of the region as shown herein, but should include deviations from shapes due to fabrication. For example, regions shown or described as flat may typically have coarse and/or non-linear characteristics. Also, the sharp angles shown can be rounded. Thus, the regions shown in the figure are schematic in nature and their shapes are not intended to show the precise shape of the area and are not intended to limit the scope of the claim.

One embodiment according to the present application will be described with reference to the accompanying drawings below.

In the proceeding of miniaturization of an optical system, it is difficult for the optical system including a traditional plastic lens to make breakthroughs in thickness and large curvature due to the limitation of injection molding technology. Thus, the thickness, intervals between the lenses, and TTL for the optical system with five lenses are difficult to break through. On the other hand, there are only about ten optional materials for plastic lenses, which limits the freedom of the aberration correction of the optical system. At present, although the hybrid lens of glass resin solves problems such as chromatic aberration to a certain extent, the injection molding process still greatly hinders the miniaturization and lightweight of the optical system. Today, the optical system requires an enormous effort even for every 1 millimeter of total track length reduction of the optical system.

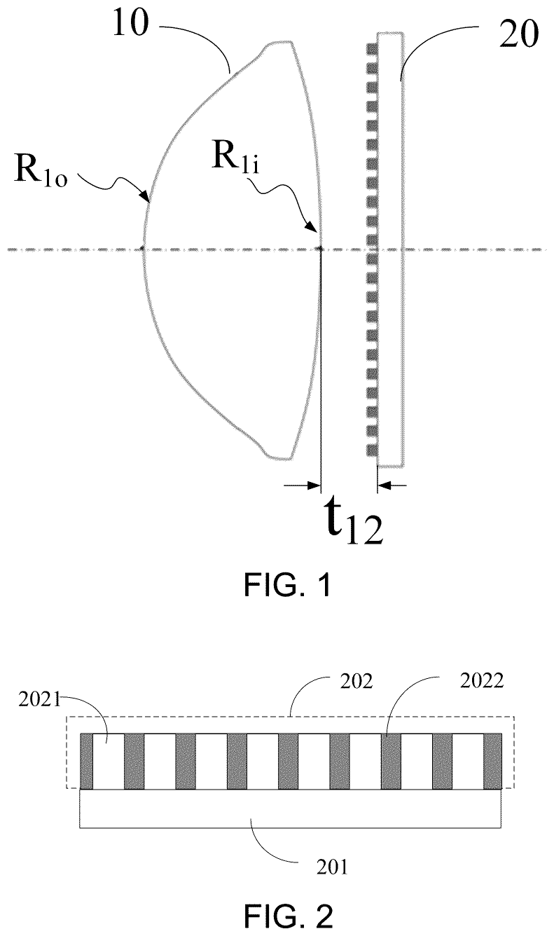

In the first aspect, a hybrid lens is provided in the present application, as shown in FIG. 1, the hybrid lens includes a first lens and a second lens in order from an object side to an image side; wherein, the first lens is a refractive lens with a positive focal length; the second lens is a metalens; each of the first lens and the second lens comprises an object-side surface facing towards the object plane and an image-side surface facing towards the image plane; both the object-side surface and the image-side surface of the first lens are aspheric surfaces; the first lens and the second lens further satisfy the conditions:

$${t}_{12} \leq 0.5 mm ;$$

$$\vert \frac{{f}_{2}}{{f}_{1}} \vert \geq 8 ;$$

$${R}_{1 i} > {R}_{1 O} ;$$

In the conditions (1-1)-(1-3), t₁₂ is a distance between the first lens and the second lens; f₁ is a focal length of the first lens; f₂ is a focal length of the second lens; R₁ᵢ is a curvature radius of the image-side surface of the first lens; R₁ₒ is a curvature radius of the object-side surface of the first lens. It should be noted that the distance t₁₂ may be less than a reference value. Optionally, when the hybrid lens is applied to consumer electronic devices, t₁₂ may be less than 0.5 mm.

Firstly, the hybrid lens is able to reduce the difficulty of wavefront aberration correction for the lenses behind the hybrid lens by combining the aspheric lens and the metalens when the hybrid lens works in a lens group that has more than 4 lenses. Secondly, if the second lens is another kind of lens except the metalens, the second lens 20 requires a higher-order surface structure such as multiple points of inflection to achieve a similar effect, but the existing manufacturing technology does not support such a complex design. Moreover, because the thickness of the metalens is significantly less than the thickness of the refractive lens, the TTL of the optical system will be reduced effectively.

According to the embodiment of the present application, the first lens may be made of an optical glass, such as crown glass, flint glass, quartz glass, etc., or various types of optical plastics, such as APL5514, OKP4HT, etc. Preferably, the first lens 10 may be made of an optical plastic. The first lens 10 uses optical plastic to achieve mass production of aspherical lenses at low cost by injection molding.

According to the embodiment of the present application, the focusing performance of the second lens 20 is less than the focusing performance of the first lens 10. The second lens 20 is used to correct the chromatic spherical aberration of the first lens 10, other monochromatic aberrations and the lateral chromatic aberration. Optionally, the absolute value of the ratio of the focal length of the second lens 20 to the focal length of the first lens 10 needs to be greater than 8.

Next, the metalens (that is, the second lens 20) provided by the present application as shown from FIG. 2 to FIG. 17 is described below.

Specifically, the metalens is a kind of metasurface, the metasurface modulates the phase, amplitude and polarization of the incident lights by the sub-wavelength nanostructures arranged in a period.

FIG. 2 shows an optional structural diagram of the metalens provided by the present embodiment. As shown in FIG. 2, the metalens 20 includes a substrate 201 and a nanostructured layer 202; and the nanostructured layer 202 is set on at least one side of the substrate; and the number of the nanostructured layer is greater than or equal to 1; each layer of the nanostructured layers includes a plurality of nanostructures 2021, and the plurality of nanostructures 2021 are arranged in a period.

According to the embodiment of the present application, optionally, the period of the nanostructures in any nanostructured layers is greater than or equal to 0.3λ_{c}, and is less than or equal to 2λ_{c}; and λ_{c} is a central wavelength of the second lens at the working waveband.

According to the embodiment of the present application, optionally, a height of the nanostructures in any nanostructured layer is greater than or equal to 0.3λ_{c}, and is less than or equal to 5λ_{c}; and λ_{c} is a central wavelength of the second lens at the working waveband.

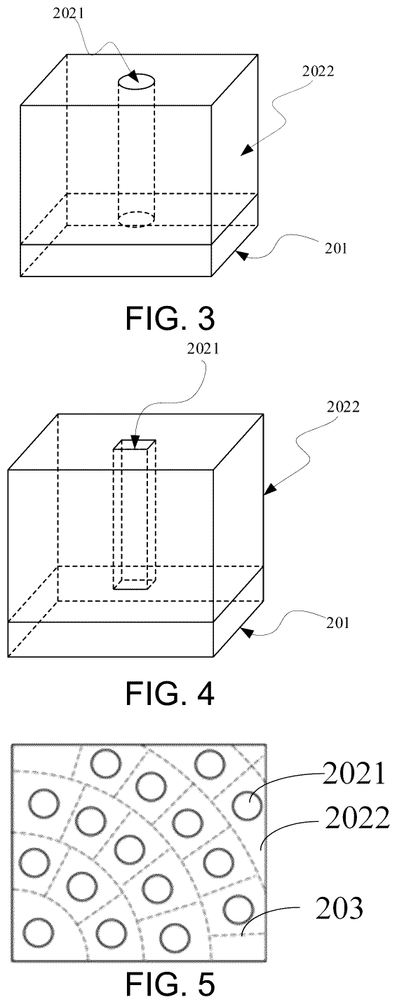

FIG. 3 and FIG. 4 show a perspective view of the nanostructure 2021 in any nanostructured layer 202 in the second lens 20. Optionally, FIG. 3 is a cylindrical structure. Optionally, the nanostructure 2021 in FIG. 4 is a positive square cylindrical structure. Optionally, as shown in FIGS. 1 and 4, the metalens also includes a filler material 2022, and the extinction coefficient of the filler material 2022 at the working waveband is less than 0.01. Optionally, the filler material 2022 includes air or other transparent or translucent materials at the working waveband. According to the embodiment of the present application, the absolute value of the difference between the refractive index of the material 2022 and the refractive index of the nanostructure 2021 should be greater than or equal to 0.5. When the metalens provided by the embodiment of the present application have at least two layers of the nanostructured layer 202, the filler material 2022 in the nanostructured layer 202 farthest from the substrate 201 may be air.

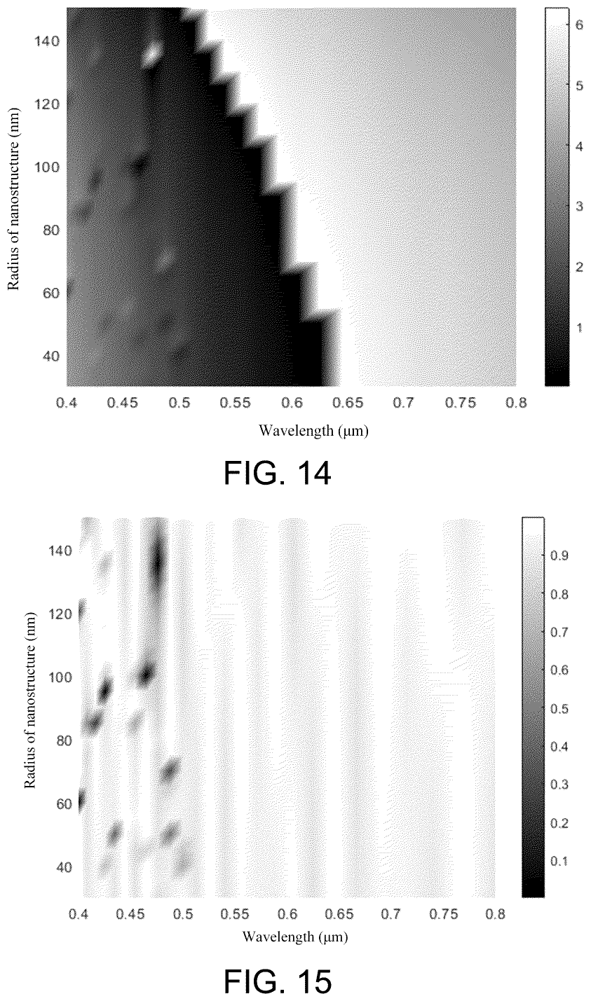

In some optional embodiments of the present application, as shown from FIG. 14 to FIG. 16, any layer of the nanostructured layer 202 includes an array arrangement of the nanostructured layer 202. The unit cell 203 is a dense packing pattern provided with the nanostructure 2021. The nanostructure 2021 may be set on the vertice or/and center of the dense packing pattern. In the embodiment of the present application, a dense packing pattern refers to one or more figures that can fill the entire plane without gaps or overlaps.

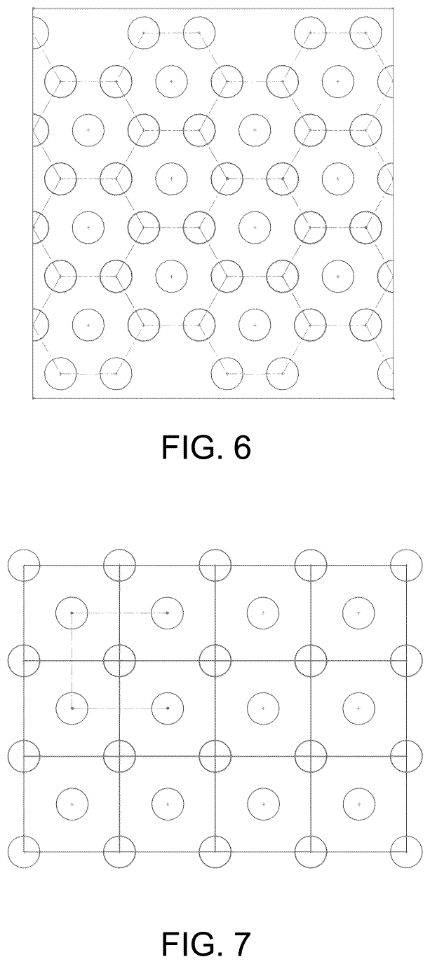

As shown in FIG. 5, according to the embodiment provided by the present application, the unit cells may be arranged in a fan-shaped array. As shown in FIG. 6, the unit cell may be arranged in a regular hexagon array. In addition, the unit cell 203 may be arranged in a regular square array. And those skilled in the field should understand that the unit cell 203 may be arranged in other shapes, and all the modifications are covered within the scope of this application.

Optionally, the wide-spectrum phase of unit cell 203 at the working waveband of the metalens also satisfies:

$$- \frac{69 rad}{μm} \leq \frac{d φ ( r = {r}_{0} , λ )}{d λ} \leq - 5 rad / μm ; \qquad ( 2 )$$

In condition (2), r is a radial coordinates of the metalens; r₀ is a distance between any position on the metalens and the center of the metalens; λ is a working wavelength of the metalens.

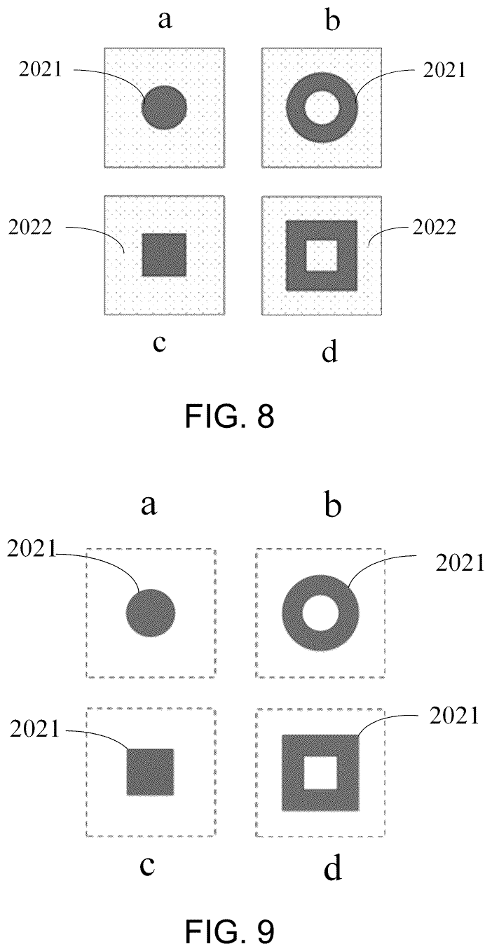

In one embodiment, the nanostructures 2021 provided by the present embodiment may be polarization-independent structures, and the polarization-independent structures apply a propagation phase to the incident lights. The embodiments as shown in FIGS. 8-9, the polarization-independent structures include cylinder structures, hollow structures, cylindrical structures, round-hole structures, hollow-round-hole structures, square column structures, square hole structures, hollow square column structures and hollow square hole structures.

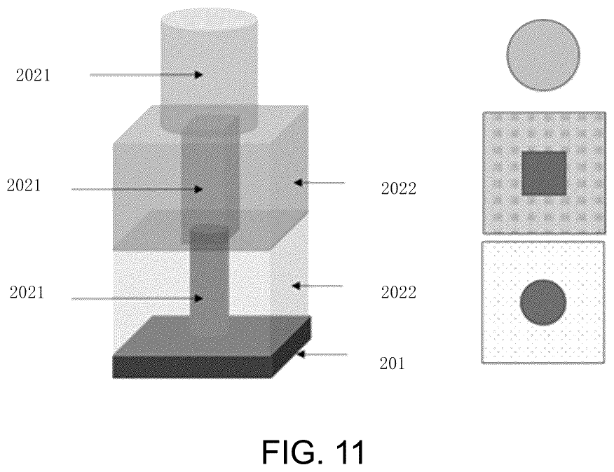

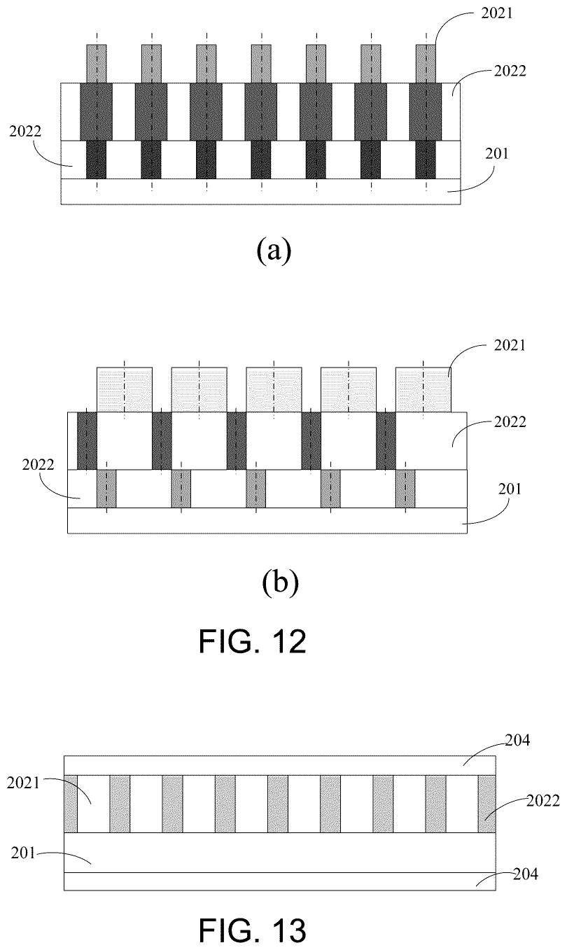

Preferably, as shown in FIG. 11, the present application provides a second lens 20 including at least two nanostructured layers 202. Optionally, as shown in (a) of FIG. 12, the plurality of nanostructures in any two adjacent nanostructured layers are in a coaxial arrangement. And the coaxial arrangement refers to the periods of the nanostructures in any adjacent nanostructured layer are the same; or the axis of the nanostructure 2021 at the same position in the two adjacent nanostructured layers coincides. Optionally, as shown in (b) of FIG. 12, the nanostructures 2021 in the adjacent nanostructured layer in at least two layers of nanostructures 202 are misaligned in the direction parallel to the substrate 201 of the metalens. The right diagram of FIG. 11 shows a perspective view of each nanostructured layer. According to the embodiment of the present application, the shape, size, or material of the nanostructure 2021 in the adjacent nanostructured layer 202 may be the same or different. According to the embodiment of the present application, the filler material 2022 in the adjacent nanostructured layer 202 may be the same or be different.

In one embodiment, “a”-“d” in FIG. 8 shows the shape of the nanostructures 2021 including a cylinder, a hollow cylinder, a square column, and a hollow square column, and the filler material 2021 is filled around the nanostructures 2021. In FIG. 8, the nanostructure 2021 is disposed at the center of the unit cell of the regular square 203. In an optional embodiment of the present application, “a”-“d” in FIG. 9 shows the shape of the nanostructures 2021 including a cylinder, a hollow cylinder, a square column and a hollow square column, and there is no filler material 2022 filled around the nanostructures 2021. In FIG. 9, the nanostructures 2021 are disposed at the center of unit cell 203 of the regular square.

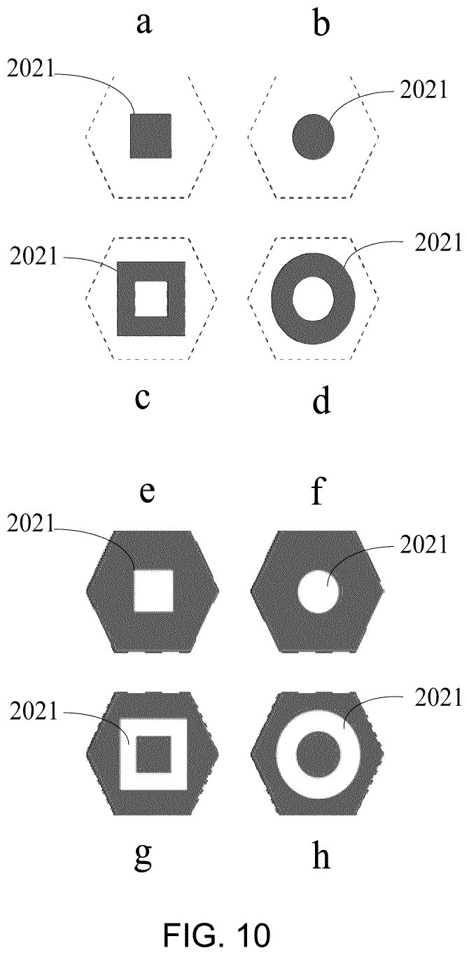

According to the embodiment of the present application, in FIG. 10, “a” to “d” shows the shape of the nanostructure 2021 including a square column, a cylinder, a hollow square column and a hollow cylinder respectively, and there is no filler material 2022 filled between the nanostructure 2021. As shown from “a” to “d” of FIG. 10, the nanostructure 2021 is disposed at the center of the unit cell 203 of the regular hexagonal shape. Optionally, “e” in FIG. 10 to “h” in FIG. 10 show the nanostructures 2021 as negative nanostructures, such as a square hole, circular, square, and circular columns. From “e” to “h” in FIG. 10, the nanostructure 2021 is a negative structure disposed at the center of the unit cell 203 of a positive hexagonal.

In one optional embodiment, as shown in FIG. 13, the metalens further includes an antireflection film 204. The antireflection film 204 is set on one side of the substrate 201 away from the nanostructured layer 202; or the antireflection film 204 is set on a side of at least one nanostructured layer 202 near the air. The antireflection film 204 is used to increase the transmittance of the incident lights and reduce the reflection of the incident lights.

According to the embodiment of the present application, the extinction coefficient of substrate 201 is less than 0.01. For example, the substrate 201 may be made of molten quartz, quartz glass, crown glass, flint glass, sapphire, crystalline silicon, amorphous silicon or hydrogenated amorphous silicon. In one embodiment, when the working waveband of the metalens is a visible waveband, the substrate 201 may be made of molten quartz, quartz glass, crown glass, flint glass, sapphire, or alkaline glass. In an optional embodiment, the material of the nanostructures 2021 is different from the material of the substrate 201. Optionally, the filler material 2022 is the same as the material of the substrate 201. Optionally, the filler material 2022 is different from the material of the substrate 201.

It should be understood that in some optional embodiments of the present application, the filler material 2022 is of the same material as the nanostructure 2021. In some optional embodiments of the present application, the filler material 2022 is different from the material of the nanostructure 2021. In one embodiment, the filler material 2022 is made of a high transmittance material with an extinction coefficient less than 0.01 at the working waveband. In one embodiment, the filler material 2022 may be made of molten quartz, quartz glass, crown glass, flint glass, sapphire, crystalline silicon, amorphous silicon, or hydrogenated amorphous silicon.

Optionally, the effective refractive index range of the metalens provided by the present application embodiment is less than 2. The effective refractive index range is the maximum refractive index of the second lens 20 minus its minimum refractive index. According to the embodiment of the present application, the phase of the metalens provided by the embodiment of the present application also meets formulas (3):

$$φ ( r , λ ) = \frac{2 π}{λ} {\sum }_{i = 1}^{N} {a}_{i} {r}^{2 i} + {φ}_{0} ( λ ) ; \qquad ( 3 - 1 )$$

$$φ ( r , λ ) = \frac{2 π}{λ} {\sum }_{i = 1}^{N} ( {a}_{i} {r}^{2 i} + \frac{{b}_{i}}{{r}^{2 i}} ) + {φ}_{0} ( λ ) ; \qquad ( 3 - 2 )$$

$$φ ( r , λ ) = \frac{2 π}{λ} {\sum }_{i = 1}^{N} \frac{{a}_{i}}{{r}^{2 i}} + {φ}_{0} ( λ ) ; \qquad ( 3 - 3 )$$

$$φ ( r , λ ) = \frac{2 π}{λ} {\sum }_{i = 1}^{N} {a}_{i} \vert {r}^{i} \vert + {φ}_{0} ( λ ) ; \qquad ( 3 - 4 )$$

$$φ ( r , λ ) = \frac{2 π}{λ} {\sum }_{i = 1}^{N} ( {a}_{i} \vert {r}^{i} \vert + \frac{{b}_{i}}{\vert {r}^{i} \vert} ) + {φ}_{0} ( λ ) ; \qquad ( 3 - 5 )$$

$$φ ( x , y , λ ) = \frac{2 π}{λ} {\sum }_{j = 1}^{N} {\sum }_{i = 1}^{j} ( {a}_{ij} {x}^{i} {y}^{j - i} + {b}_{ij} {x}^{j - i} {y}^{i} ) + {φ}_{0} ( λ ) ; \qquad ( 3 - 6 )$$

$$φ ( x , y , λ ) = \frac{2 π}{λ} ( {f}_{2} - \sqrt{{{f}_{2}}^{2} + {r}^{2}} ) + {φ}_{0} ( λ ) ; \qquad ( 3 - 7 )$$

$$φ ( x , y , λ ) = \frac{2 π}{λ} ( \sqrt{{{f}_{2}}^{2} + {r}^{2}} - {f}_{2} ) + {φ}_{0} ( λ ) ; \qquad ( 3 - 8 )$$

r is a distance between any center of nanostructure and the center of the metalens; λ is a working wavelength of the metalens; φ₀(λ) is any phase corresponding to the working wavelength; (x, y) is the coordinates of the metalens (in some cases, it can be regarded as the coordinates of the surface of the substrate 201); f_{ML} is a focal length of the metalens (the second lens 20); aᵢ and bᵢ are real coefficients. It should be noted that the phase of the metalens can be expressed in high-degree polynomials, and high-degree polynomials include both odd and even polynomials. In order not to break the rotational symmetry of the phase of metalens, in general, the phase of the even-degree polynomials is only optimized, which greatly reduces the design degree of freedom of the metalens. From the formulas (3-1) to (3-8), formulas (3-4)-(3-6) are capable of satisfying the optimization of the phase of the odd-degree polynomial without breaking its rotational symmetry, and greatly increase the optimization degree of freedom of the metalens.

Optionally, the real phase of the second lens 20 provided by the present application can match with the ideal theoretical phase, that is, the matching degree of the wide spectrum of the metalens satisfies the formula (4) as follows:

$$η = \frac{1}{{λ}_{max} - {λ}_{min}} {\int }_{{λ}_{min}}^{{λ}_{max}} \vert exp [ i ( {φ}_{the} ( λ ) - {φ}_{real} ( λ ) ) ] \vert d λ ; \qquad ( 4 )$$

λₘₐₓ is the longest wavelength at the working waveband and λₘᵢₙ is the shortest wavelength at the working waveband. For example, λₘₐₓ=700 nm, λₘᵢₙ=400 nm. φₜₕₑ is the target theoretical phase and φᵣₑₐₗ is the real phase in the database.

### Embodiment 1

In one embodiment, the present embodiment provides a second lens 20. The second lens 20 includes a substrate 201 and two nanostructured layers 202 setting on substrate 201. From the direction away from the substrate 201, the two nanostructured layers 202 are the first nanostructured layer and the second nanostructured layer. The specific parameter items are as shown in Table 1. FIG. 14 shows the phase diagram of the embodiment provided by the present application, and the horizontal coordinate of FIG. 14 is the wavelength of the incident lights, and the vertical coordinate is the radius of the nanostructures 2021. FIG. 15 shows a transmittance diagram of the second lens 20 in embodiment 1, the horizontal coordinate of FIG. 15 is the wavelength of the incident lights, and the vertical coordinate is the radius of the nanostructures 2021.

Optionally, the wide-spectrum phase of unit cell 203 and the working waveband of the second lens 20 also satisfy:

$$- 69 rad / μm \leq \frac{d φ ( r = {r}_{0} , λ )}{d λ} \leq - 5 rad / μm ; \qquad ( 2 - 1 )$$

r is a radial coordinates of the metalens; r₀ is a distance between any position on the metalens and the center of the metalens; λ is a working wavelength of the metalens.

TABLE 1

| Items | | Parameter | |
|---|---|---|---|
| Working wavelength | | Visible light | |
| Material of substrate | | Quartz glass | |
| Period of regular hexagonal | | 400 | nm |
| The first | Type of nanostructure | Cylinder | |
| nanostructured | Material of nanostructure | Silicon nitride | |
| layer | Filler material | Silicon dioxide (SiO₂) | |
| | Height | 700 | nm |
| | Diameter of nanostructure | 70 | nm |
| The second | Type of nanostructure | Cylinder | |
| nanostructured | Material of nanostructure | Air | |
| layer | Filler material | Silicon dioxide (SiO₂) | |
| | Height | 700 | nm |
| | Diameter of nanostructure | 60~340 | nm |

### Embodiment 2

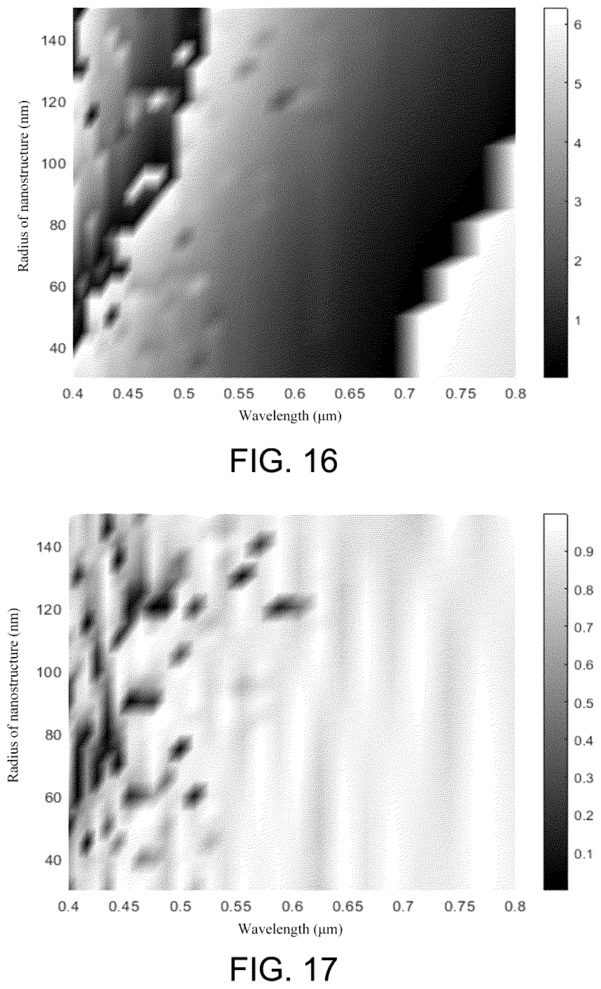

In one embodiment, the present embodiment provides a second lens 20. The second lens 20 includes a substrate 201 and two nanostructured layers 202 setting on substrate 201. From the direction away from the substrate 201, the two nanostructured layers 202 are the first nanostructured layer and the second nanostructured layer. The specific parameter items are as shown in Table 2. FIG. 16 shows the phase diagram of the embodiment provided by the present application, and the horizontal coordinate of FIG. 16 is the wavelength of the incident lights, and the vertical coordinate is the radius of the nanostructures 2021. FIG. 17 shows a transmittance diagram of the second lens 20 in embodiment 2, the horizontal coordinate of FIG. 17 is the wavelength of the incident lights, and the vertical coordinate is the radius of the nanostructures 2021.

Optionally, the wide-spectrum phase of unit cell 203 and the working waveband of the second lens 20 also satisfy:

$$- 69 rad / μm \leq \frac{d φ ( r = {r}_{0} , λ )}{d λ} \leq - 5 rad / μm ; \qquad ( 2 - 1 )$$

r is a radial coordinates of the metalens; r₀ is a distance between any position on the metalens and the center of the metalens; λ is a working wavelength of the metalens.

TABLE 2

| Items | | Parameter item | |
|---|---|---|---|
| Working wavelength | | Visible light | |
| Material of substrate | | Quartz glass | |
| Period of regular hexagonal | | 400 | nm |
| The first | Type of nanostructure | Hollow circular cylinder | |
| nanostructured | Material of nanostructure | Silicon nitride | |
| layer | Filler material | Silicon dioxide (SiO₂) | |
| | Height | 700 | nm |
| | Inner diameter | 70 | nm |
| | Outer diameter | 220 | nm |
| The second | Type of nanostructure | Cylinder | |
| nanostructured | Material of nanostructure | Titanium dioxide | |
| layer | Filler material | Silicon dioxide (SiO₂) | |
| | Height | 700 | nm |
| | Diameter of nanostructure | 60~340 | nm |

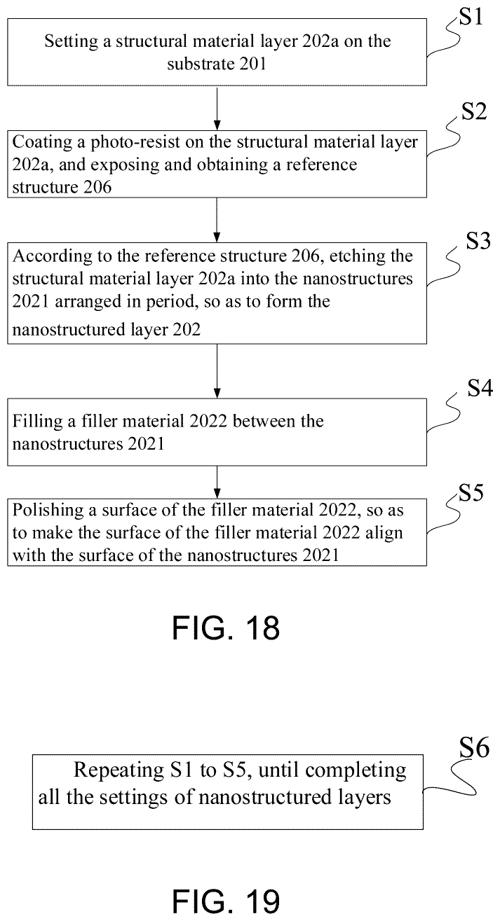

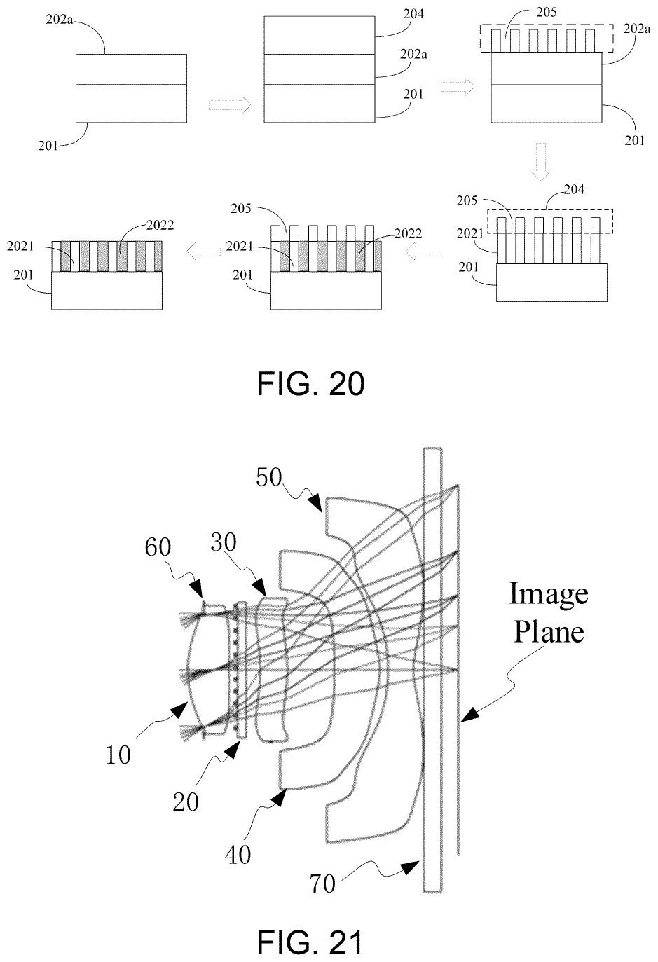

In the second aspect, the manufacturing method for the metalens is provided, and the manufacturing method is applied to the second lens (metalens) 20 in any embodiment provided by the present application. As shown in FIGS. 18 to 20, the manufacturing method comprises S1-S5:
S1. setting a structural material layer 202a on the substrate 201;
S2. coating a photo-resist on the structural material layer 202a, and exposing and obtaining a reference structure 206; wherein, the structural material layer 202a is used to be manufactured into the nanostructures.
S3. etching the structural material layer 202a into the nanostructures 2021 arranged in a period according to the reference structure 206, so as to form the nanostructured layer 202;
S4. filling a filler material 2022 between the nanostructures 2021;
S5. polishing a surface of the filler material 2022, so as to make the surface of the filler material 2022 align with the surface of the nanostructures 2021.

Optionally, as shown in FIG. 19, the manufacturing method further includes:
S6. repeating S1 to S5, until completing all the nanostructured layers.

In the third aspect, the present embodiment provides an optical system, and the optical system is shown in FIGS. 21, 27, 33, 35 and 39. The optical system in order from an object side to an image side, the optical elements include: an aperture slot 60, a first lens 10, a second lens 20, a third lens 30, a fourth lens 40 and a fifth lens 50.

Each optical element includes an object-side surface facing towards the object plane and an image-side surface facing towards the image plane. The third lens 30 is a refractive lens, and the curvature radius of the object-side surface of the third lens 30 is negative. The fourth lens 40 is a refractive lens, and the object-side surface of the fourth lens 40 is a concave surface. The fifth lens 50 is a refractive lens, and the object-side surface of the fourth lens 40 is a concave surface. There is at least one aspheric surface in the surfaces of the third lens 30, the fourth lens 40 and the fifth lens 50, and the aspheric surface has one point of inflection.

Further, the optical system provided by the present application satisfies the conditions as follows:

$$f / EPD < 3 ; \qquad ( 5 - 1 )$$

$$25 ° \leq HFOV \leq 55 ° ; \qquad ( 5 - 2 )$$

$$0.05 mm \leq {d}_{2} \leq 2 mm ; \qquad ( 5 - 3 )$$

f is a focal length of the optical system; EPD is an entrance pupil diameter of the optical system; HFOV is a half of the maximum field of view; d₂ is a thickness of the second lens 20.

According to an optional embodiment provided by the present application, the optical system satisfies the condition (6):

$$0.2 \leq {R}_{1 o} / {f}_{1} \leq 0.8 ; \qquad ( 6 )$$

wherein R₁ₒ is the current radius of the object-side surface of the first lens 10; f₁ is a focal length of the central wavelength at the working waveband.

According to an optional embodiment provided by the present application, the optical system further satisfies condition (7):

$$( {V}_{1} + {V}_{4} ) / 2 - {V}_{3} > 20 ; \qquad ( 7 )$$

V₁ is an Abbe number of the first lens; V₃ is an Abbe number of the third lens; V₄ is an Abbe number of the fourth lens.

According to an optional embodiment provided by the present application, the optical system further satisfies condition (8):

$$1.2 < TTL / ImgH < 1.8 ; \qquad ( 8 )$$

TTL is a total track length of the optical system. ImgH is a maximum imaging height of the optical system. The maximum imaging height refers to half of the diagonal length of the effective sensing area of the electronic image sensor. TTL is a total track length of the optical system, that is, the distance between the object-side surface of the first lens and the image plane of the optical system.

According to an optional embodiment provided by the present application, the optical system further satisfies condition (9):

$$\frac{{f}_{2}}{f} > 10 ; \qquad ( 9 )$$

f₂ is a focal length of the second lens 20 in the optical system; f is a focal length of the optical system.

In the optical system provided by the present application, the aspheric surfaces in the third lens 30, fourth lens 40 and the fifth lens 50 are shown in condition (10):

$$z = \frac{{Cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + {Hr}^{18} + {Jr}^{20} ; \qquad ( 10 )$$

z represents the surface vector parallel to z axis, and z axis is an optical axis of the optical system; c is the central curvature radius of the aspheric surface; k is a constant of center of quadric surface, A˜J are higher order coefficients.

According to the embodiment of the present application, the fifth lens 50 is used to correct the optical aberrations of the first lens 10 to the fourth lens 40, the optical aberrations include but are not limited to the monochromatic aberrations and chromatic aberrations.

### Embodiment 3

The optical system in order from an object side to an image side, the six optical elements include: an aperture slot (STO) 60, a first lens 10, a second lens 20, a third lens 30, a fourth lens 40 and a fifth lens 50.

Each optical element includes an object-side surface facing towards the object plane and an image-side surface facing towards the image plane. The third lens 30 is a refractive lens, and the curvature radius of the object-side surface of the third lens 30 is negative. The fourth lens 40 is a refractive lens, and the object-side surface of the fourth lens 40 is a concave surface. The fifth lens 50 is a refractive lens, and the object-side surface of the fourth lens 40 is a concave surface. There is at least one aspheric surface in the surfaces of the third lens 30, the fourth lens 40 and the fifth lens 50, and the aspheric surface has one point of inflection.

Further, the optical system provided by the present application satisfies the conditions as follows:

$$f / EPD < 3 ; \qquad ( 5 - 1 )$$

$$25 ° \leq HFOV \leq 55 ° ; \qquad ( 5 - 2 )$$

$$0.05 mm \leq {d}_{2} \leq 2 mm ; \qquad ( 5 - 3 )$$

f is a focal length of the optical system; EPD is an entrance pupil diameter of the optical system; HFOV is a half of the maximum field of view; d₂ is a thickness of the second lens 20.

The specific parameters of the optical system provided by embodiment 3 are shown in Table 3-1. “VIS” in Table 3-1 represents a visible waveband. The curvature, thickness, refractive index, and other parameter items of each lens in the optical system are shown in Table 3-2. The aspherical coefficients of each surface of each lens in the optical system are shown in Table 3-3.

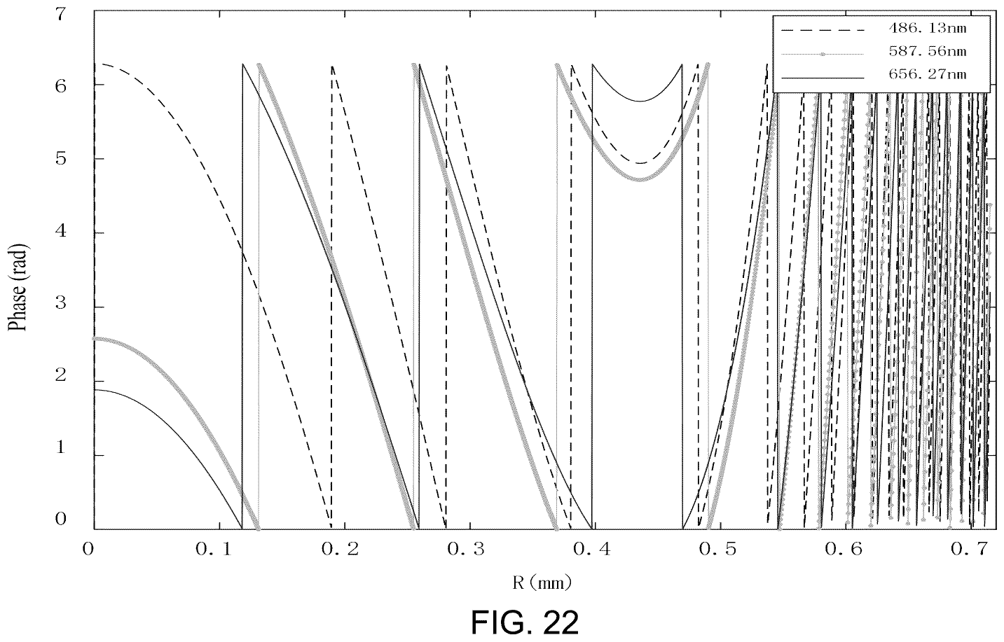

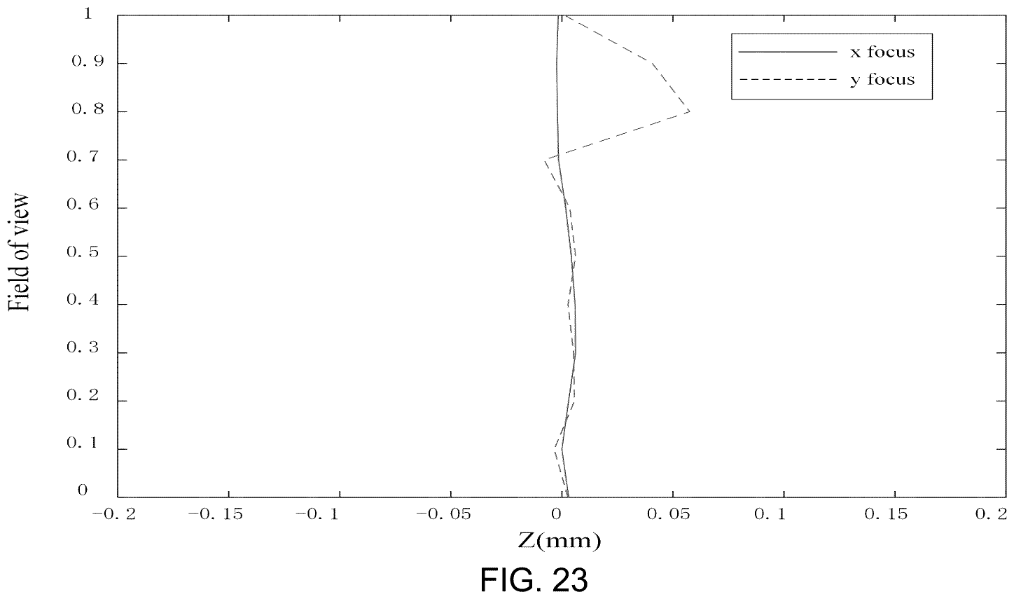

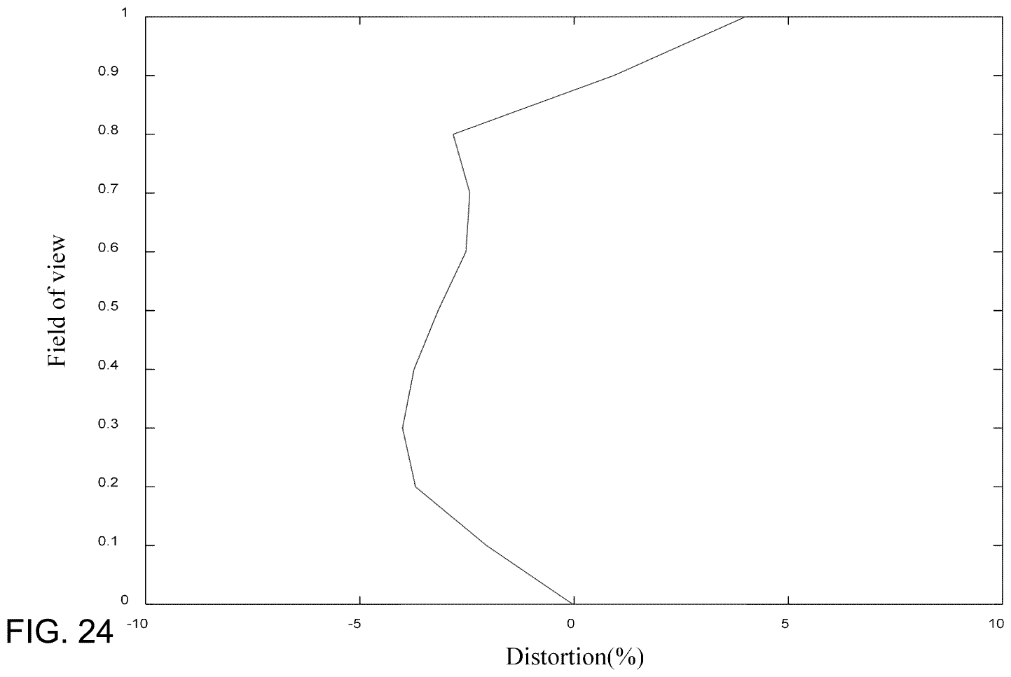

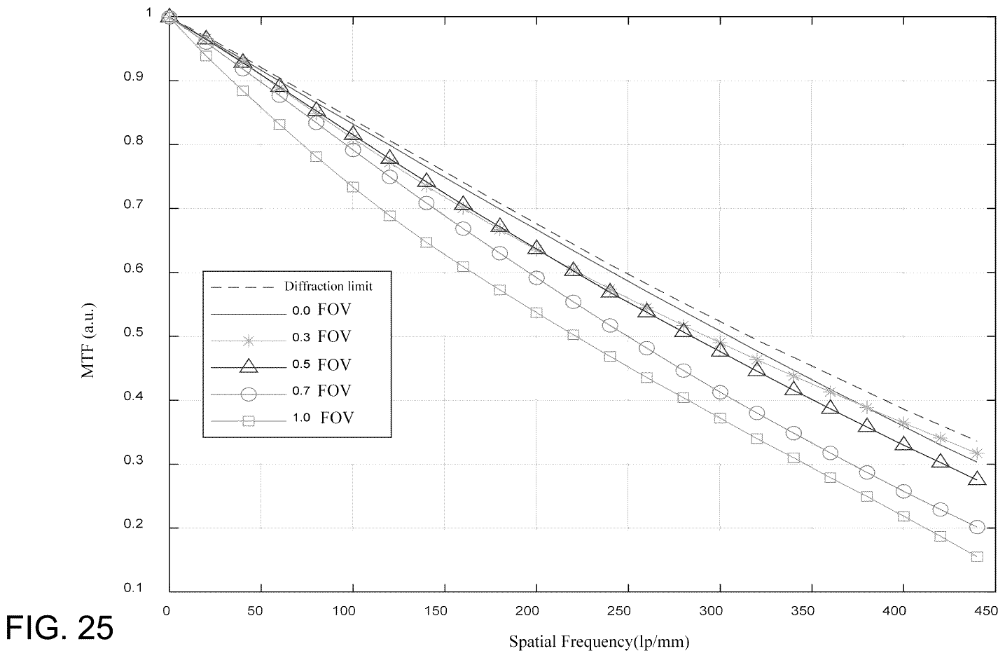

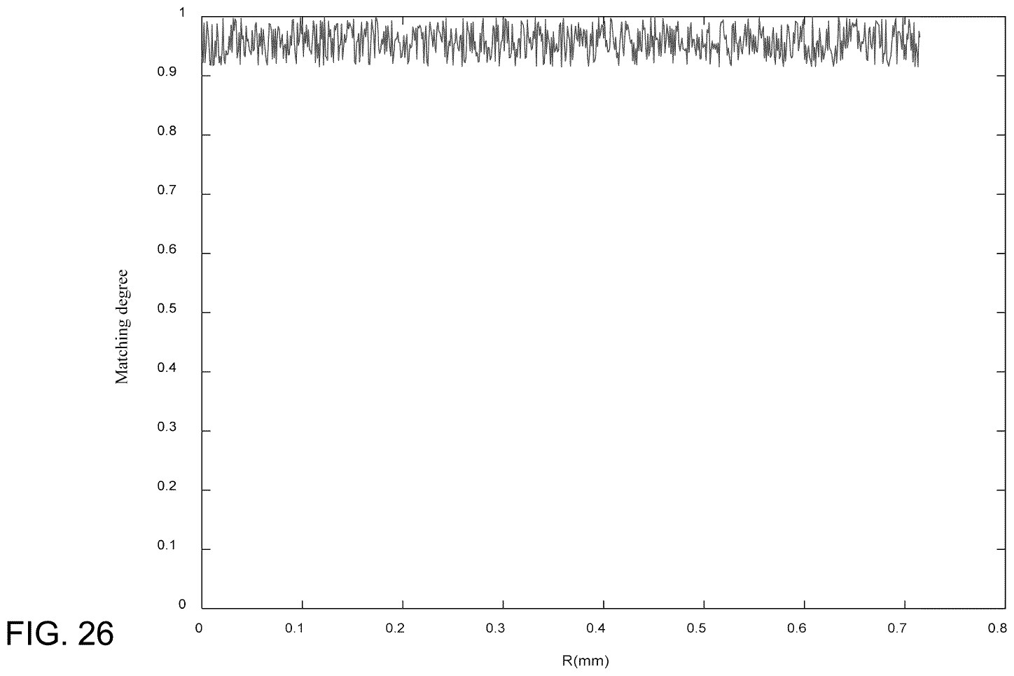

FIG. 22 shows a phase modulation diagram of the second lens 20 (metalens) in the optical system provided by embodiment 3 at the wavelength of 486.13 nm, 587.56 nm, and 656.27 nm. It can be seen in FIG. 22 that the phases cover 0-2π of the second lens 20 at different wavelengths. FIG. 23 shows an astigmatism diagram of the optical system. According to FIG. 23, the meridional astigmatism of the optical system at the different fields of view from 0 to 1 is less than 0.5 mm, and the sagittal astigmatism is about 0. FIG. 24 shows a distortion diagram of the optical system (that is, a curvature field diagram). According to FIG. 24, the distortion of the optical system at the different fields of view from 0 to 1 is less than 5%. FIG. 25 shows the MTF (Modulation Transfer Function) diagram of the optical system in embodiment 3. According to FIG. 25, the values of the MTF of the optical system are close to the diffraction limit. FIG. 26 shows a matching degree of the second lens 20 in the optical system provided by embodiment 3. FIG. 26 shows a matching degree between the actual phase and the theoretical phase of the second lens 20 in embodiment 3 is greater than 90%. The optical system in embodiment 3 has a high MTF and has good control of astigmatism and distortion, therefore the optical system has good imaging quality.

TABLE 3-1

| Parameter item | Value |
|---|---|
| Working wavelength(WL) | VIS(400-700 nm) |
| Effective focal length(EFL) | 3 mm |
| Field of view(2ω) | 74° |
| F number | 2.23 |
| Image height (ImgH) | 2.4 mm |
| Total track length(TTL) | 3 mm |

TABLE 3-2

| Numbered | | Radius | Thickness | |
|---|---|---|---|---|
| surface | Type of surface | (mm) | (mm) | Material |
| STO | Spherical surface | Infinite | −0.2 | |
| L₁ₒ | Aspheric surface | 1.3516 | 0.5 | 540000.560000 |
| L₁ᵢ | Aspheric surface | 32.154 | 0.1 | |
| L₂ₒ | Structural surface | Infinite | 0.1 | 45800.676000 |
| | (metalens) | | | |
| L₂ᵢ | Spherical surface | Infinite | 0.17 | |
| L₃ₒ | Aspheric surface | −2.154 | 0.31 | 640000.233000 |
| L₃ᵢ | Aspheric surface | −2.063 | 0.5411 | |
| L₄ₒ | Aspheric surface | −3.816 | 0.5368 | 540000.560000 |
| L₄ᵢ | Aspheric surface | −0.9165 | 0.1 | |
| L₅ₒ | Aspheric surface | −2.0145 | 0.3 | |
| L₅ᵢ | Aspheric surface | 0.75215 | 0.121 | |
| IR filterₒ | Spherical surface | Infinite | 0.21 | 517000.642000 |
| IR filterᵢ | Spherical surface | Infinite | 0.2 | |
| Image plane | Spherical surface | Infinite | 0 | |

TABLE 3-3

| Numbered | | | | | | | | |
|---|---|---|---|---|---|---|---|---|
| surface | L₁ₒ | L₁ᵢ | L₃ₒ | L₃ᵢ | L₄ₒ | L₄ᵢ | L₅ₒ | L₅ᵢ |
| K | −0.214369 | −4.06E+14 | 1.8355006 | 2.4021641 | 12.681124 | −15.52651 | 0.0979845 | −18.347 |
| A | −0.03762 | −0.087422 | 0.1900968 | 0.2628902 | 0.249111 | −0.002898 | −0.145052 | −0.141458 |
| B | −0.069432 | −0.130611 | 0.2530896 | 0.1688753 | −0.764278 | 0.0723163 | 0.1066917 | 0.0916126 |
| C | −0.107581 | −0.219408 | 0.3355255 | −0.047257 | 1.1244709 | −0.168923 | 0.0144468 | −0.036888 |
| D | 0.0711536 | 0.3679241 | −0.434025 | 0.7654238 | −1.361617 | −0.048718 | −0.005582 | 0.003874 |
| E | −0.328271 | −0.108221 | −0.044851 | 0.0363856 | −0.430563 | 0.0572538 | −0.003259 | 0.001169 |
| F | −0.33331 | 0.0603896 | 1.003612 | −3.298457 | 2.3858284 | 0.049775 | 0.0011186 | −4.66E−05 |
| G | 0.5693051 | −0.172991 | −0.957944 | 4.8241917 | −2.061175 | −0.027568 | −0.000349 | −4.84E−05 |

### Embodiment 4

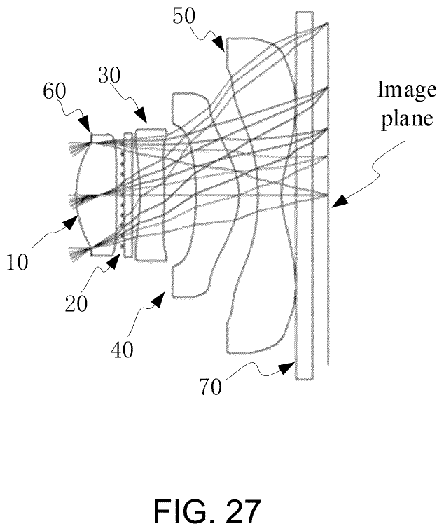

In one embodiment, as shown in FIG. 27, the optical system in order from an object side to an image side, the optical elements include: an aperture slot (STO) 60, a first lens 10, a second lens 20, a third lens 30, a fourth lens 40 and a fifth lens 50.

Each optical element includes an object-side surface facing towards the object plane and an image-side surface facing towards the image plane. The third lens 30 is a refractive lens, and the curvature radius of the object-side surface of the third lens 30 is negative. The fourth lens 40 is a refractive lens, and the object-side surface of the fourth lens 40 is a concave surface. The fifth lens 50 is a refractive lens, and the object-side surface of the fourth lens 40 is a concave surface. There is at least one aspheric surface in the surfaces of the third lens 30, the fourth lens 40 and the fifth lens 50, and the aspheric surface has one point of inflection.

Further, the optical system provided by embodiment 4 of the present application satisfies the conditions as follows:

$$f / EPD < 3 ; \qquad ( 5 - 1 )$$

$$25 ° \leq HFOV \leq 55 ° ; \qquad ( 5 - 2 )$$

$$0.05 mm \leq {d}_{2} \leq 2 mm ; \qquad ( 5 - 3 )$$

f is a focal length of the optical system; EPD is an entrance pupil diameter of the optical system; HFOV is a half of the maximum field of view; d₂ is a thickness of the second lens 20.

The specific parameters of the optical system provided by embodiment 4 are shown in Table 4-1. “VIS” in Table 4-1 represents a visible waveband. The curvature, thickness, refractive index, and other parameter items of each lens in the optical system are shown in Table 4-2. The aspherical coefficients of each surface of each lens in the optical system are shown in Table 4-3.

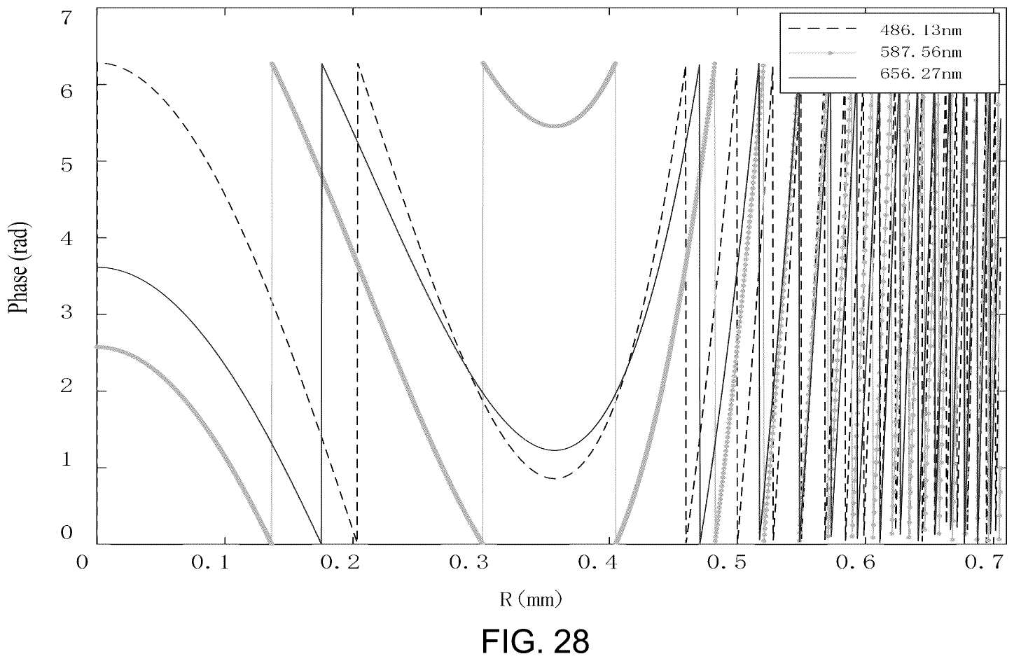

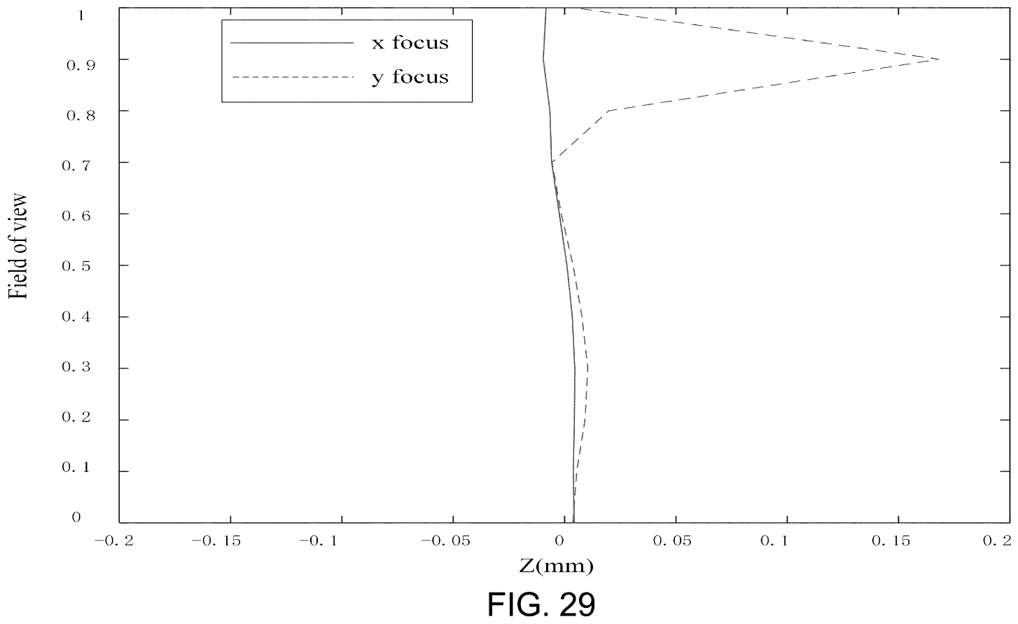

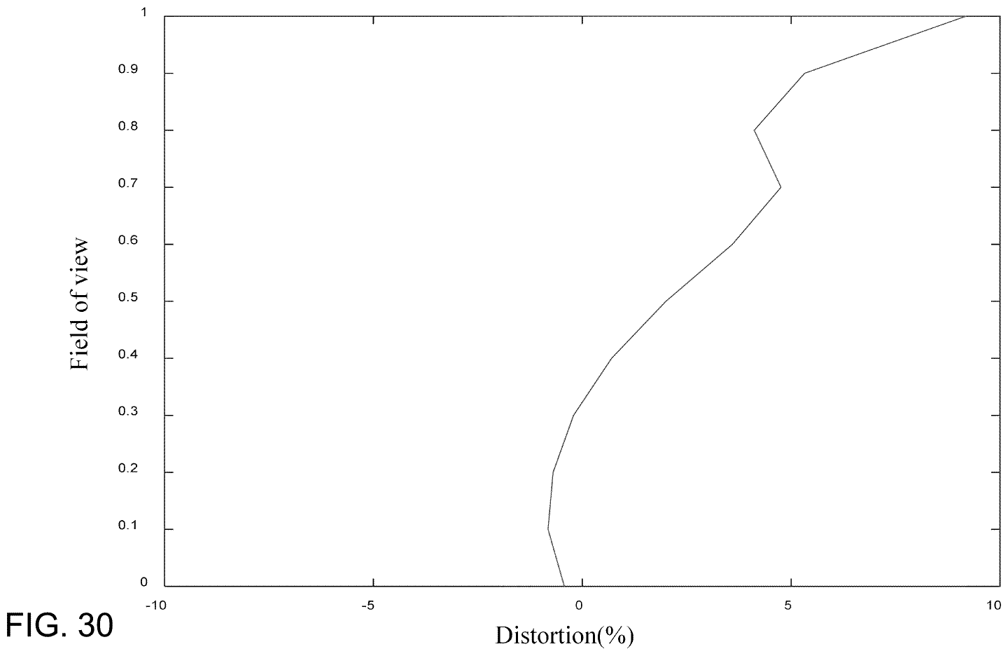

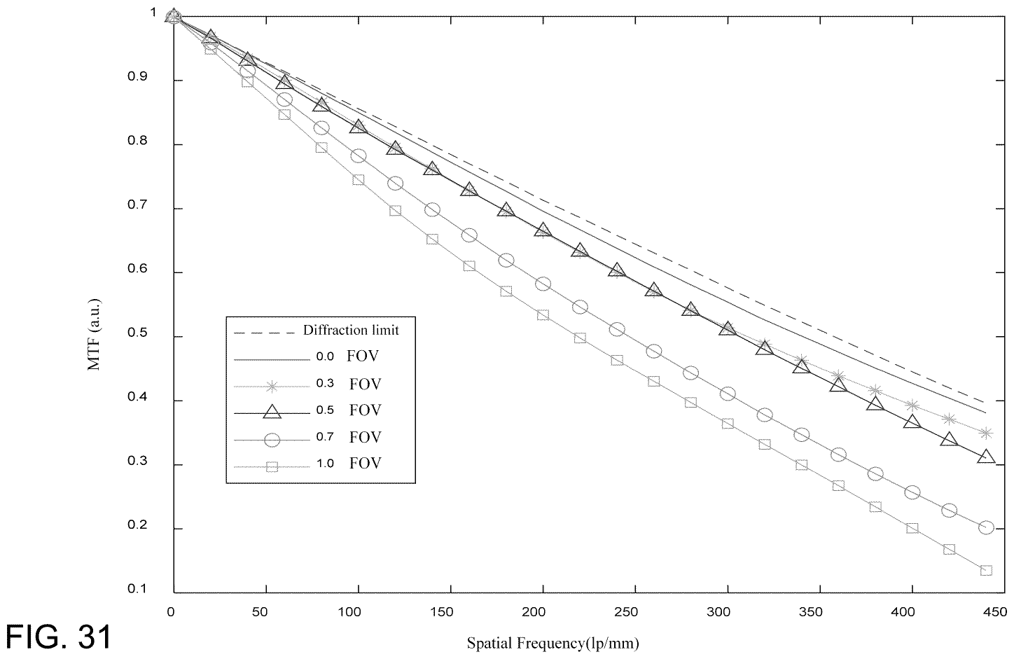

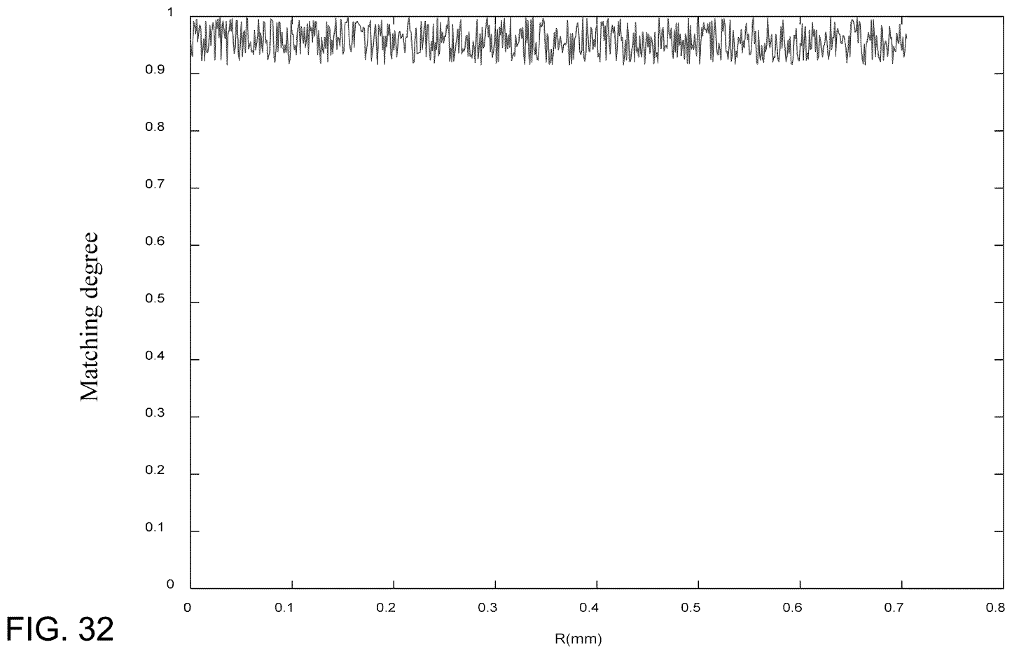

FIG. 28 shows a phase modulation diagram of the second lens 20 (metalens) in the optical system provided by embodiment 4 at the wavelength of 486.13 nm, 587.56 nm, and 656.27 nm. It can be seen in FIG. 28 that the phases cover 0-2π of the second lens 20 at different wavelengths. FIG. 29 shows an astigmatism diagram of the optical system. According to FIG. 29, the meridional astigmatism of the optical system at the different fields of view from 0 to 1 is less than 0.5 mm, and the sagittal astigmatism is about 0. FIG. 30 shows a distortion diagram of the optical system (that is, a curvature field diagram). According to FIG. 30, the distortion of the optical system at the different fields of view from 0 to 1 is less than 5%. FIG. 31 shows the MTF (Modulation Transfer Function) diagram of the optical system in embodiment 4. According to FIG. 31, the values of the MTF of the optical system are close to the diffraction limit. FIG. 32 shows a matching degree of the second lens 20 in the optical system provided by embodiment 4. FIG. 32 shows a matching degree between the actual phase and the theoretical phase of the second lens 20 in embodiment 4 is greater than 90%. The optical system in embodiment 4 has a high MTF and has good control of astigmatism and distortion, therefore the optical system has good imaging quality.

TABLE 4-1

| Parameter item | Value |
|---|---|
| Working wavelength(WL) | VIS(400-700 nm) |
| Effective focal length(EFL) | 3 mm |
| Field of view(2ω) | 80° |
| F number | 2.3 |
| Image height (ImgH) | 2.52 mm |
| Total track length(TTL) | 3 mm |

TABLE 4-2

| Numbered | | Radius | Thickness | |
|---|---|---|---|---|
| surface | Type of surface | (mm) | (mm) | Material |
| STO | Spherical surface | Infinite | −0.2 | |
| L₁ₒ | Aspheric surface | 1.2239 | 0.513 | 540000.560000 |
| L₁ᵢ | Aspheric surface | 10.186 | 0.1 | |
| L₂ₒ | Structural surface | Infinite | 0.1 | 45800.676000 |
| | (metalens) | | | |
| L₂ᵢ | Spherical surface | Infinite | 0.17 | |
| L₃ₒ | Aspheric surface | −2.544 | 0.3021 | 640000.233000 |
| L₃ᵢ | Aspheric surface | −4.124 | 0.4315 | |
| L₄ₒ | Aspheric surface | −2.6894 | 0.5453 | 540000.560000 |
| L₄ᵢ | Aspheric surface | −0.8165 | 0.2373 | |
| L₅ₒ | Aspheric surface | −4.0153 | 0.3 | |
| L₅ᵢ | Aspheric surface | 0.9915 | 0.1856 | |
| IR filterₒ | Spherical surface | Infinite | 0.21 | 517000.642000 |
| IR filterᵢ | Spherical surface | Infinite | 0.2 | |
| Image plane | Spherical surface | Infinite | 0 | |

TABLE 4-3

| Numbered | | | | | | | | |
|---|---|---|---|---|---|---|---|---|
| surface | L₁ₒ | L₁ᵢ | L₃ₒ | L₃ᵢ | L₄ₒ | L₄ᵢ | L₅ₒ | L₅ᵢ |
| K | −0.000749 | −4.06E+14 | 2.2518444 | 18.868178 | 2.6888455 | −4.578323 | 2.592737 | −9.332866 |
| A | −0.017747 | −0.044258 | 0.3127932 | 0.3921431 | 0.1125137 | −0.15808 | −0.156999 | −0.127855 |
| B | −0.026243 | −0.069844 | −0.230708 | −0.152065 | −0.156596 | 0.2419152 | 0.0965121 | 0.0889393 |
| C | −0.073263 | −0.269552 | 0.0518365 | −0.205591 | 0.2156153 | −0.102261 | 0.0078824 | −0.03808 |
| D | 0.0448327 | 0.2873876 | −0.118825 | 0.7148901 | −0.69733 | −0.049012 | −0.005653 | 0.00362 |
| E | −0.274769 | −0.305406 | 0.3184067 | 0.238886 | 0.1087521 | 0.0498764 | −0.001244 | 0.0011816 |
| F | −0.025164 | −0.289273 | 0.8039119 | −2.77495 | 1.3853962 | 0.0438 | −6.07E−05 | −2.21E−05 |
| G | −0.268615 | 0.4951387 | −0.869856 | 3.7170483 | −1.560565 | −0.033307 | 0.0001114 | −4.65E−05 |

### Embodiment 5

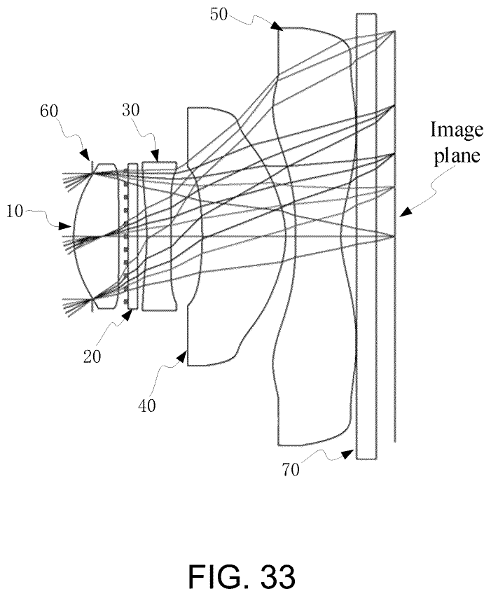

In one embodiment, as shown in FIG. 33, the optical system in order from an object side to an image side, the optical elements include: an aperture slot (STO) 60, a first lens 10, a second lens 20, a third lens 30, a fourth lens 40 and a fifth lens 50.

Each optical element includes an object-side surface facing towards the object plane and an image-side surface facing towards the image plane. The third lens 30 is a refractive lens, and the curvature radius of the object-side surface of the third lens 30 is negative. The fourth lens 40 is a refractive lens, and the object-side surface of the fourth lens 40 is a concave surface. The fifth lens 50 is a refractive lens, and the object-side surface of the fourth lens 40 is a concave surface. There is at least one aspheric surface in the surfaces of the third lens 30, the fourth lens 40 and the fifth lens 50, and the aspheric surface has one point of inflection.

Further, the optical system provided by embodiment 5 of the present application satisfies the conditions as follows:

$$f / EPD < 3 ; \qquad ( 5 - 1 )$$

$$25 ° \leq HFOV \leq 55 ° ; \qquad ( 5 - 2 )$$

$$0.05 mm \leq {d}_{2} \leq 2 mm ; \qquad ( 5 - 3 )$$

f is a focal length of the optical system; EPD is an entrance pupil diameter of the optical system; HFOV is a half of the maximum field of view; d₂ is a thickness of the second lens 20.

The specific parameters of the optical system provided by embodiment 4 are shown in Table 5-1. “VIS” in Table 5-1 represents a visible waveband. The curvature, thickness, refractive index, and other parameter items of each lens in the optical system are shown in Table 5-2. The aspherical coefficients of each surface of each lens in the optical system are shown in Table 5-3.

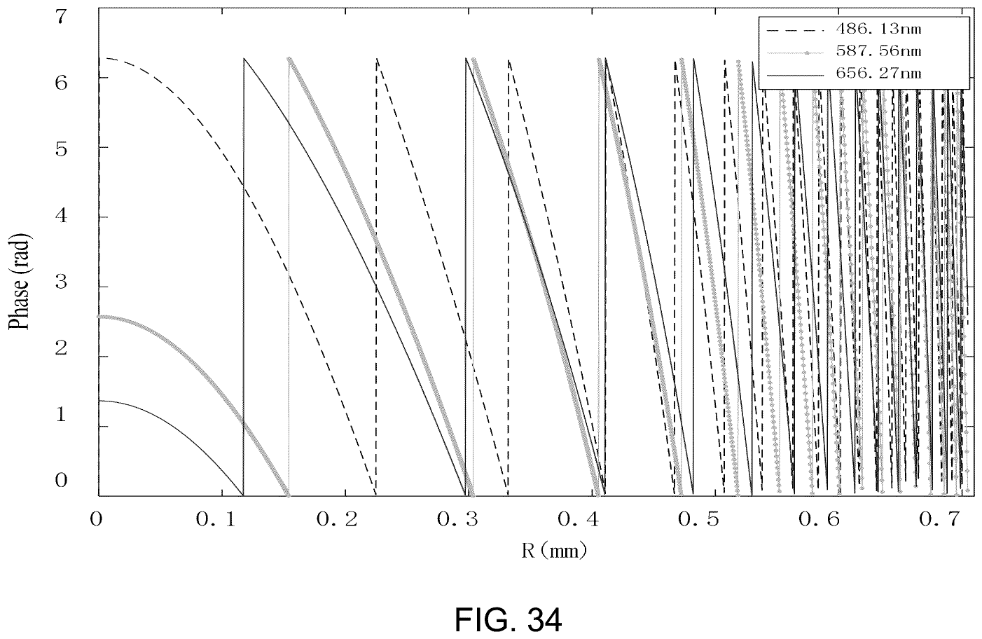

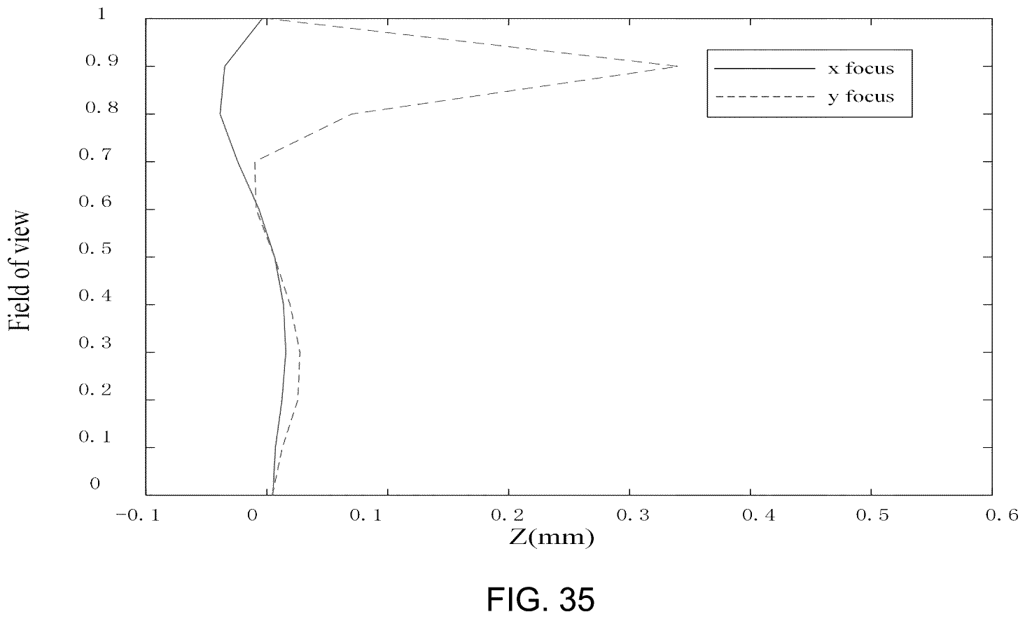

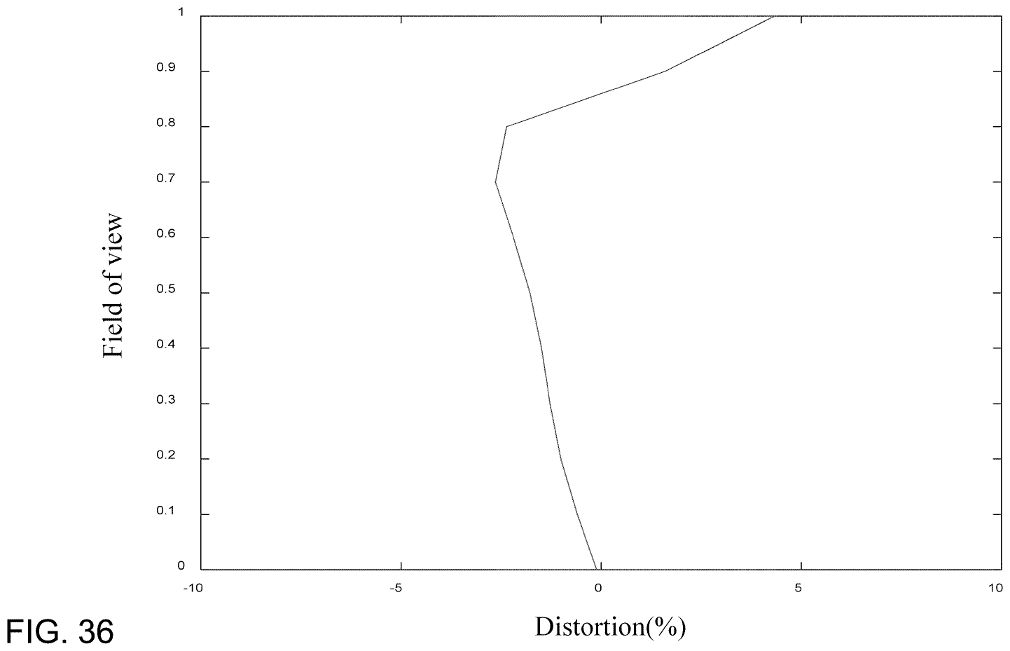

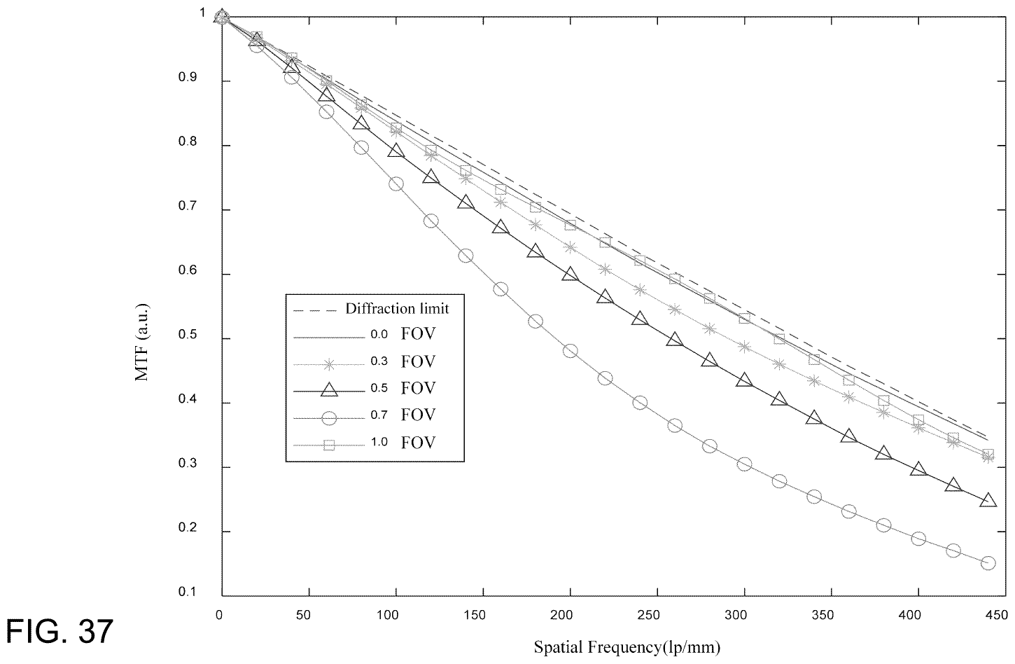

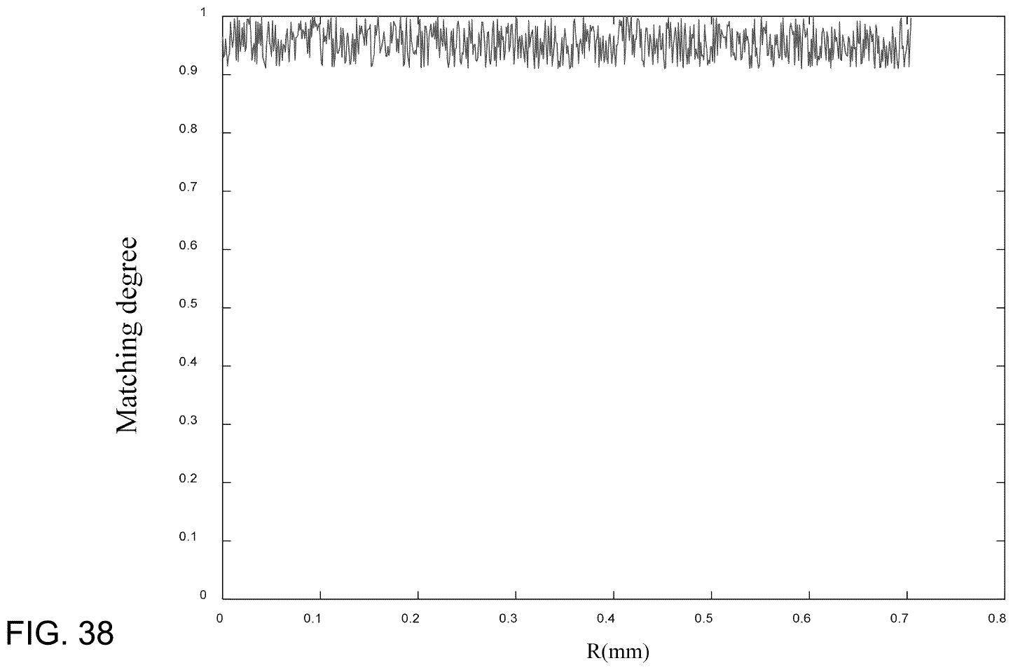

FIG. 34 shows a phase modulation diagram of the second lens 20 (metalens) in the optical system provided by embodiment 5 at the wavelength of 486.13 nm, 587.56 nm, and 656.27 nm. It can be seen in FIG. 34 that the phases cover 0-2π of the second lens 20 at different wavelengths. FIG. 35 shows an astigmatism diagram of the optical system. According to FIG. 35, the meridional astigmatism of the optical system at the different fields of view from 0 to 1 is less than 0.5 mm, and the sagittal astigmatism is about 0. FIG. 36 shows a distortion diagram of the optical system (that is, a curvature field diagram). According to FIG. 36, the distortion of the optical system at the different fields of view from 0 to 1 is less than 5%. FIG. 37 shows the MTF (Modulation Transfer Function) diagram of the optical system in embodiment 5. According to FIG. 37, the values of the MTF of the optical system are close to the diffraction limit. FIG. 38 shows a matching degree of the second lens 20 in the optical system provided by embodiment 5. FIG. 38 shows a matching degree between the actual phase and the theoretical phase of the second lens 20 in embodiment 5 is greater than 90%. The optical system in embodiment 5 has a high MTF and has good control of astigmatism and distortion, therefore the optical system has good imaging quality.

TABLE 5-1

| Parameter item | Value |
|---|---|
| Working wavelength(WL) | VIS(400-700 nm) |
| Effective focal length(EFL) | 3.2 mm |
| Field of view(2ω) | 72° |
| F number | 2.25 |
| Image height (ImgH) | 2.2 mm |
| Total track length(TTL) | 3.2 mm |

TABLE 5-2

| Numbered | | Radius | Thickness | |
|---|---|---|---|---|
| surface | Type of surface | (mm) | (mm) | Material |
| STO | Spherical surface | Infinite | −0.2 | |
| L₁ₒ | Aspheric surface | 1.1648 | 0.5271 | 540000.560000 |
| L₁ᵢ | Aspheric surface | 25.0253 | 0.1 | |
| L₂ₒ | Structural surface | Infinite | 0.1 | 45800.676000 |
| | (metalens) | | | |
| L₂ᵢ | Spherical surface | Infinite | 0.17 | |
| L₃ₒ | Aspheric surface | −2.9124 | 0.300 | 640000.233000 |
| L₃ᵢ | Aspheric surface | −5.154 | 0.2862 | |
| L₄ₒ | Aspheric surface | −2.2645 | 0.8425 | 540000.560000 |
| L₄ᵢ | Aspheric surface | −0.8564 | 0.1552 | |
| L₅ₒ | Aspheric surface | −4.5651 | 0.3862 | |
| L₅ᵢ | Aspheric surface | 0.9030 | 0.1913 | |
| IR filterₒ | Spherical surface | Infinite | 0.21 | 517000.642000 |
| IR filterᵢ | Spherical surface | Infinite | 0.2 | |
| Image plane | Spherical surface | Infinite | 0 | |

TABLE 5-3

| Numbered | | | | | | | | |
|---|---|---|---|---|---|---|---|---|
| surface | L₁ₒ | L₁ᵢ | L₃ₒ | L₃ᵢ | L₄ₒ | L₄ᵢ | L₅ₒ | L₅ᵢ |
| K | −0.491095 | −6.31E+14 | −14.1898 | −78.90052 | −39.62093 | −5.954318 | 5.6418178 | −9.582495 |
| A | 0.0216042 | −0.01207 | 0.2947213 | 0.4504062 | −0.207024 | −0.115291 | −0.124955 | −0.106183 |
| B | −0.001498 | −0.007738 | −0.525834 | −0.415772 | 0.3536858 | 0.1559928 | 0.0762642 | 0.0487329 |
| C | −0.051478 | −0.346361 | 0.339347 | −0.115966 | −1.051939 | −0.133585 | 0.0035896 | −0.016119 |
| D | −0.005 | −0.002429 | 0.2511444 | 1.0487362 | −0.457967 | −0.050725 | −0.003391 | 0.0022874 |
| E | −0.268493 | −0.217347 | 0.3426131 | 0.2089876 | 1.0886473 | 0.0548999 | −0.000626 | 0.0002532 |
| F | 0.7608525 | 2.1516223 | 0.0161401 | −2.93258 | 0.8900178 | 0.0486709 | 2.32E−05 | −5.21E−05 |
| G | −1.423849 | −3.370752 | −1.754058 | 4.6047071 | −2.943259 | −0.030006 | 5.61E−05 | −3.79E−06 |

### Embodiment 6

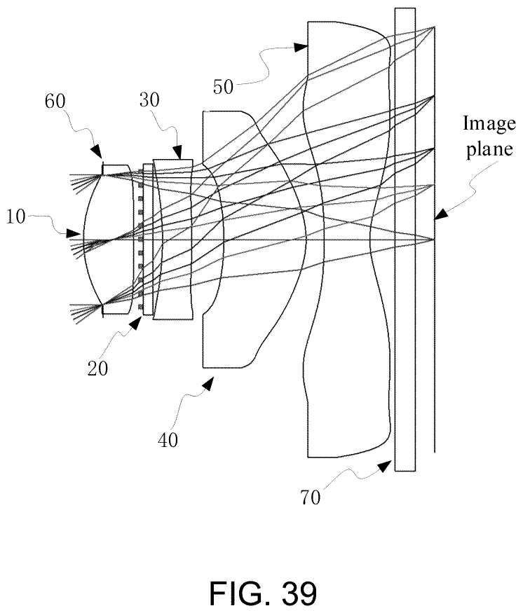

In one embodiment, as shown in FIG. 39, the optical system in order from an object side to an image side, the optical elements include: an aperture slot (STO) 60, a first lens 10, a second lens 20, a third lens 30, a fourth lens 40 and a fifth lens 50.

Each optical element includes an object-side surface facing towards the object plane and an image-side surface facing towards the image plane. The third lens 30 is a refractive lens, and the curvature radius of the object-side surface of the third lens 30 is negative. The fourth lens 40 is a refractive lens, and the object-side surface of the fourth lens 40 is a concave surface. The fifth lens 50 is a refractive lens, and the object-side surface of the fourth lens 40 is a concave surface. There is at least one aspheric surface in the surfaces of the third lens 30, the fourth lens 40 and the fifth lens 50, and the aspheric surface has one point of inflection.

Further, the optical system provided by embodiment 6 of the present application satisfies the conditions as follows:

$$f / EPD < 3 ; \qquad ( 5 - 1 )$$

$$25 ° \leq HFOV \leq 55 ° ; \qquad ( 5 - 2 )$$

$$0.05 mm \leq {d}_{2} \leq 2 mm ; \qquad ( 5 - 3 )$$

f is a focal length of the optical system; EPD is an entrance pupil diameter of the optical system; HFOV is a half of the maximum field of view; d₂ is a thickness of the second lens 20.

The specific parameters of the optical system provided by embodiment 6 are shown in Table 6-1. “VIS” in Table 6-1 represents a visible waveband. The curvature, thickness, refractive index, and other parameter items of each lens in the optical system are shown in Table 6-2. The aspherical coefficients of each surface of each lens in the optical system are shown in Table 6-3.

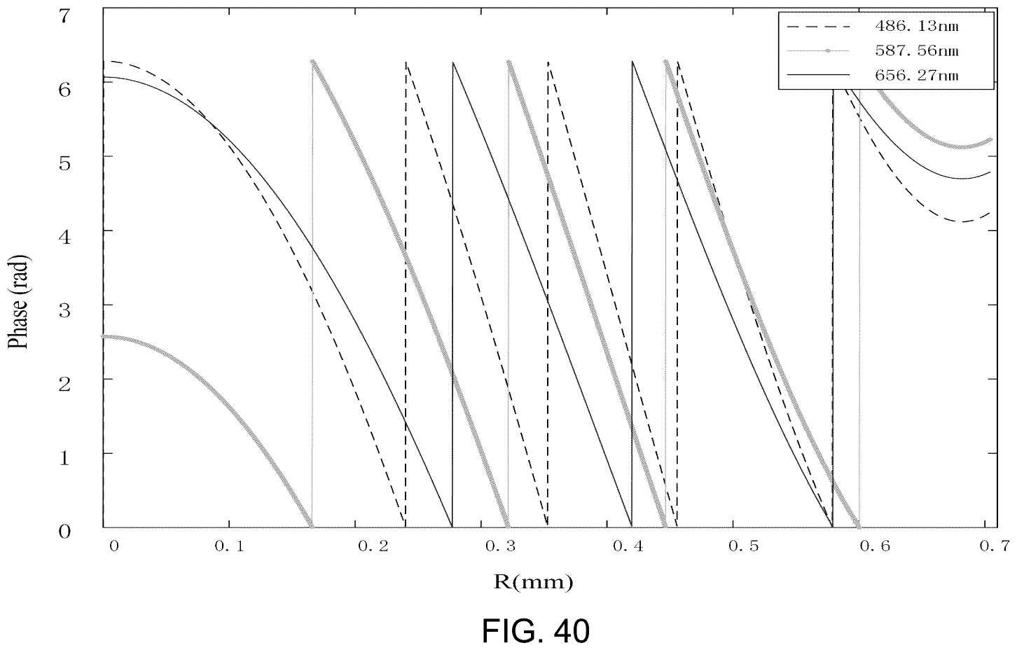

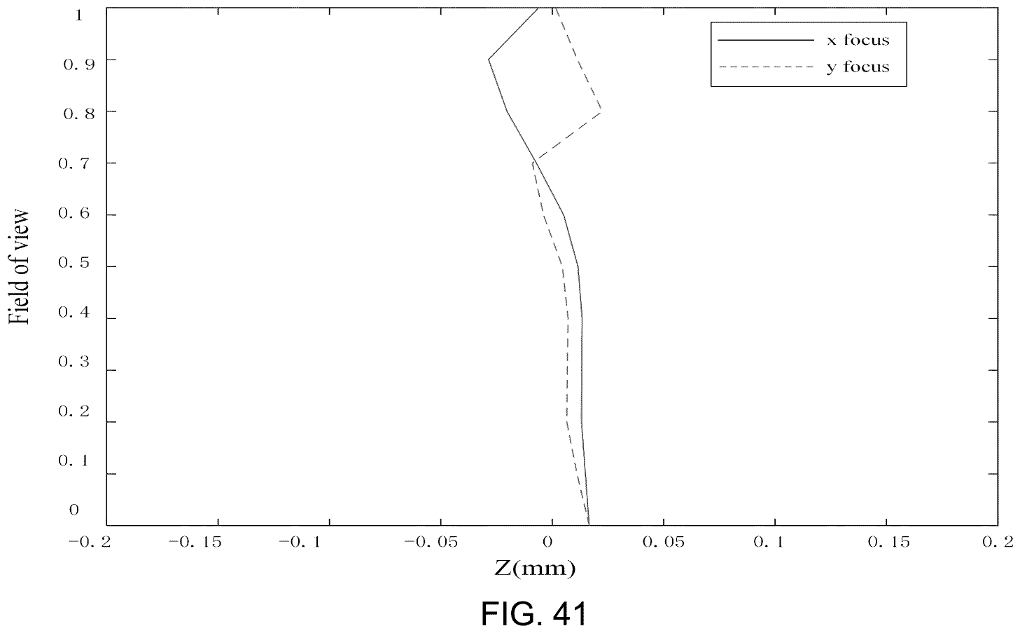

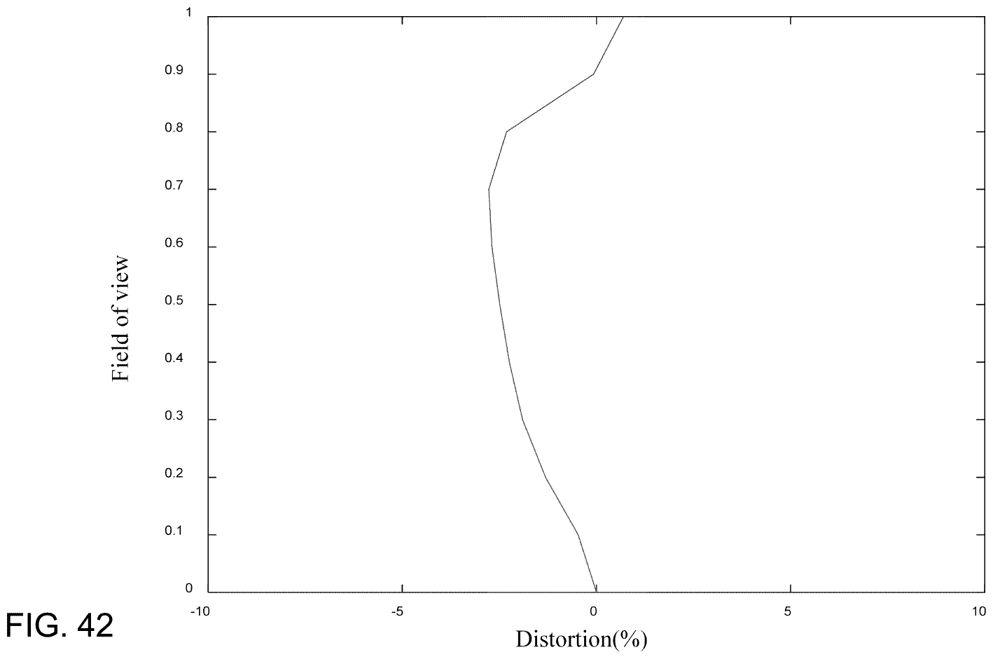

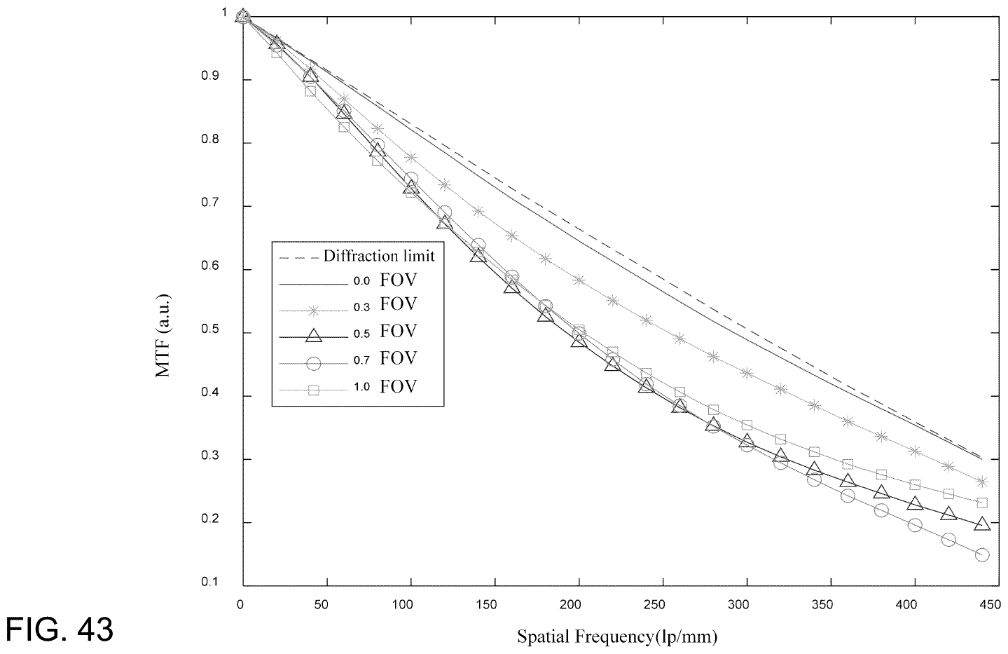

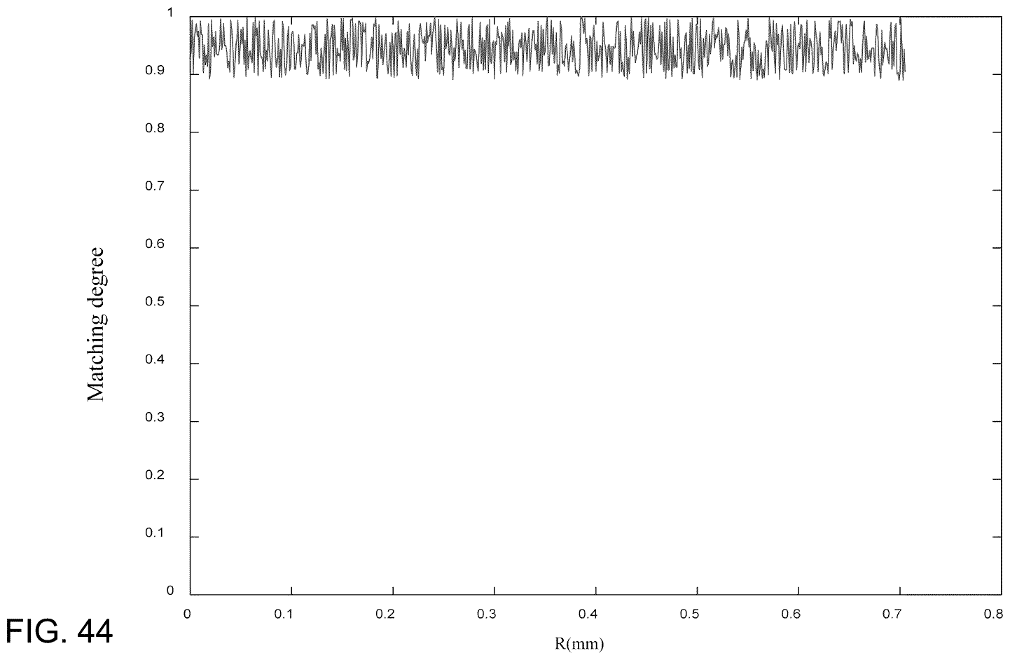

FIG. 40 shows a phase modulation diagram of the second lens 20 (metalens) in the optical system provided by embodiment 6 at the wavelength of 486.13 nm, 587.56 nm, and 656.27 nm. It can be seen in FIG. 40 that the phases cover 0-2π of the second lens 20 at different wavelengths. FIG. 41 shows an astigmatism diagram of the optical system. According to FIG. 41, the meridional astigmatism of the optical system at the different fields of view from 0 to 1 is less than 0.4 mm, and the sagittal astigmatism is about 0. FIG. 42 shows a distortion diagram of the optical system (that is, a curvature field diagram). According to FIG. 42, the distortion of the optical system at the different fields of view from 0 to 1 is less than 5%. FIG. 43 shows the MTF (Modulation Transfer Function) diagram of the optical system in embodiment 6. According to FIG. 43, the values of the MTF of the optical system are close to the diffraction limit. FIG. 44 shows a matching degree of the second lens 20 in the optical system provided by embodiment 6. FIG. 44 shows a matching degree between the actual phase and the theoretical phase of the second lens 20 in embodiment 6 is greater than 90%. The optical system in embodiment 6 has a high MTF and has good control of astigmatism and distortion, therefore the optical system has good imaging quality.

TABLE 6-1

| Parameter item | Value |
|---|---|
| Working wavelength(WL) | VIS(400-700 nm) |
| Effective focal length(EFL) | 3.4 mm |
| Field of view(2ω) | 72° |
| F number | 2.25 |
| Image height (ImgH) | 2.2 mm |
| Total track length(TTL) | 3.4 mm |

TABLE 6-2

| Numbered | | Radius | Thickness | |
|---|---|---|---|---|
| surface | Type of surface | (mm) | (mm) | Material |
| STO | Spherical surface | Infinite | −0.2 | |
| L₁ₒ | Aspheric surface | 1.2314 | 0.5141 | 540000.560000 |
| L₁ᵢ | Aspheric surface | 259.02 | 0.1 | |
| L₂ₒ | Structural surface | Infinite | 0.1 | 45800.676000 |
| | (metalens) | | | |
| L₂ᵢ | Spherical surface | Infinite | 0.1 | |
| L₃ₒ | Aspheric surface | −2.5124 | 0.3022 | 640000.233000 |
| L₃ᵢ | Aspheric surface | −4.3465 | 0.3305 | |
| L₄ₒ | Aspheric surface | −2.1576 | 0.8460 | 540000.560000 |
| L₄ᵢ | Aspheric surface | −0.8756 | 0.1865 | |
| L₅ₒ | Aspheric surface | −4.9411 | 0.4692 | |
| L₅ᵢ | Aspheric surface | 0.8460 | 0.2590 | |
| IR filterₒ | Spherical surface | Infinite | 0.21 | 517000.642000 |
| IR filterᵢ | Spherical surface | Infinite | 0.2 | |
| Image plane | Spherical surface | Infinite | 0 | |

TABLE 6-3

| Numbered | | | | | | | | |
|---|---|---|---|---|---|---|---|---|
| surface | L₁ₒ | L₁ᵢ | L₃ₒ | L₃ᵢ | L₄ₒ | L₄ᵢ | L₅ₒ | L₅ᵢ |
| K | −0.393266 | −4.25E+05 | −5.88396 | −44.93869 | −43.9609 | −5.637136 | 6.9877808 | −8.943677 |
| A | 0.0106527 | −0.011637 | 0.2431639 | 0.3538222 | −0.264163 | −0.153507 | −0.121639 | −0.107763 |
| B | 0.0402688 | −0.081946 | −0.549118 | −0.47029 | 0.4819366 | 0.1666206 | 0.0761005 | 0.0506746 |
| C | −0.219804 | −0.417391 | 0.1046128 | −0.168273 | −1.169357 | −0.125468 | 0.0034332 | −0.015869 |
| D | 0.0321898 | 0.2292786 | 0.2136382 | 0.983795 | −0.572012 | −0.051196 | −0.003478 | 0.0022538 |
| E | 0.0163455 | 0.1841681 | 0.8687778 | 0.3213615 | 1.3260873 | 0.053905 | −0.00068 | 0.0002212 |
| F | 0.5533191 | 0.2745173 | 0.720994 | −2.566741 | 1.5169686 | 0.0484744 | 2.17E−05 | −6.22E−05 |
| G | −1.573637 | −1.271773 | −2.381041 | 3.0869994 | −3.369657 | −0.029544 | 6.55E−05 | −8.67E−07 |

It should be noted that in an optional embodiment, the optical system provided by the present application further includes an infrared filter 70 (IR filter). The infrared filter 70 is set between the fifth lens 50 and the image plane of the optical system. The working waveband of the optical system is a visible waveband, and the infrared filter 70 is beneficial to filter the lights at the infrared waveband to improve the imaging quality. It should be noted that the metalens (second lens 20) can be manufactured through a semiconductor process, and has the advantages of lightweight, thin thickness, simple structure and process, low cost and high consistency of mass production.

In conclusion, the hybrid lens improves the design freedom of the optical system by combining the metalens and the refractive lens. The manufacturing method of metalens obtains the metalens with at least one nanostructured layer by layer-by-layer manufacturing, which increases the aspect ratio of the metalens and improves the design freedom of the metalens. The focal length of the optical system provided by the present application is greater than 3 mm and the TTL of the optical system is less than 3 mm by using the metalens and the refractive lens in the hybrid lens as the first lens and the second lens in the optical system, which realizes the miniaturization and lightweight of the optical system.

The above is only a specific embodiment of the embodiments of this disclosure, but the scope of protection of the embodiment of this disclosure is not limited to this. And those skilled in the field can easily think of any change or substitution for this disclosure, which should be covered within the protection scope of this disclosure. Therefore, the scope of the protection of the present disclosure shall be the scope of the claims.

What is claimed is:

1. A hybrid lens, the hybrid lens comprising a first lens and a second lens in order from an object side to an image side;
wherein, the first lens is a refractive lens with a positive focal length; the second lens is a metalens;
each of the first lens and the second lens comprises an object-side surface facing towards the object plane and an image-side surface facing towards the image plane;
both the object-side surface and the image-side surface of the first lens are aspheric surfaces;
the first lens and the second lens further satisfy the conditions:
$${t}_{12} \leq 0.5 mm ;$$
$$\vert \frac{{f}_{2}}{{f}_{1}} \vert \geq 8 ;$$
$${R}_{1 i} > {R}_{1 O} ;$$
wherein, t₁₂ is a distance between the first lens and the second lens; f₁ is a focal length of the first lens; f₂ is a focal length of the second lens; R₁ᵢ is a curvature radius of the image-side surface of the first lens; R₁ₒ is a curvature radius of the object-side surface of the first lens.

2. The hybrid lens according to claim 1, wherein the second lens comprises a substrate and at least one nanostructured layers;
each of the nanostructured layers comprises a plurality of nanostructures;
the plurality of nanostructures are arranged in an array.

3. The hybrid lens according to claim 2, wherein a period of the nanostructures in any nanostructured layers is greater than or equal to 0.3λ_{c}, and is less than or equal to 2λ_{c};
wherein, λ_{c} is a central wavelength of the second lens at a working waveband.

4. The hybrid lens according to claim 2, wherein a height of the nanostructures in any nanostructured layer is greater than or equal to 0.3λ_{c}, and is less than or equal to 5λ_{c};
wherein, λ_{c} is a central wavelength of the second lens at a working waveband.

5. The hybrid lens according to claim 2, wherein the at least one nanostructured layer comprises a plurality of unit cells, and the plurality of unit cells are arranged in an array;
each unit cell is a dense packing pattern, and the nanostructures are set on a vertice and a center of the dense packing pattern.

6. The hybrid lens according to claim 2, wherein the plurality of nanostructures are polarization-independent structures.

7. The hybrid lens according to claim 6, wherein the polarization-independent structures comprise cylinder structures, hollow structures, cylindrical structures, round-hole structures, hollow-round-hole structures, square column structures, square hole structures, hollow square column structures and hollow square hole structures.

8. The hybrid lens according to claim 2, wherein the metalens further comprises an antireflection film;
the antireflection film is set on at least one side of the substrate.

9. The hybrid lens according to claim 5, wherein a wide-spectrum phase of unit cell of the second lens also satisfies:
$$- \frac{69 rad}{μm} \leq \frac{d φ ( r = {r}_{0} , λ )}{d λ} \leq - 5 rad / μm ;$$
r is a radial coordinates of the metalens; r₀ is a distance between any position on the metalens and the center of the metalens; λ is a working wavelength of the metalens.

10. The hybrid lens according to claim 2, wherein the plurality of nanostructures in any two adjacent nanostructured layers are coaxial.

11. The optical system according to claim 1, wherein the metalens comprises at least two nanostructured layers; the nanostructures in any adjacent nanostructured layer are non-coaxial along a direction parallel with the substrate.

12. A manufacturing method for a metalens, wherein the manufacturing method is used to manufacture the metalens of the hybrid lens claimed as claim 1, and the manufacturing method comprises:
S1. setting a structural material layer on the substrate;
S2. coating a photo-resist on the structural material layer, and exposing and obtaining a reference structure;
S3. etching the structural material layer into the nanostructures arranged in period according to the reference structure, so as to form the nanostructured layer;
S4. filling a filler material between the nanostructures;
S5. polishing a surface of the filler material, so as to make the surface of the filler material align with the surface of the nanostructures.

13. The manufacturing method for a metalens according to claim 12, wherein the manufacturing method further comprises:
S6. repeating S1 to S5, until completing all the nanostructured layers.

14. An optical system, wherein the optical system comprises five optical elements, wherein in order from an object side to an image side, the five optical elements comprise: an aperture slot, a hybrid lens, a third lens, a fourth lens and a fifth lens;
each of five optical elements comprises an object-side surface facing towards the object plane and an image-side surface facing towards the image plane;
wherein the third lens is an aspheric refractive lens, and a curvature radius of the object-side surface of the third lens is negative;
the fourth lens is a refractive lens, and the object-side surface of the fourth lens is a concave surface;
the fifth lens is a refractive lens, and the object-side surface of the fifth lens is a concave surface;
and there is at least one aspheric surface in the object-side and image-side surfaces of the third lens, the fourth lens and the fifth lens, and the aspheric surface has one point of inflection;
the optical system satisfies the formulas as follows:
$$f / EPD < 3 ;$$
$$25 ° \leq HFOV \leq 55 ° ;$$
$$0.05 mm \leq {d}_{2} \leq 2 mm ;$$
wherein, f is a focal length of the optical system; EPD is an entrance pupil diameter of the optical system; HFOV is a half of the maximum field of view; d₂ is a thickness of the second lens.

15. The optical system according to claim 14, wherein the optical system satisfies the following condition:
$$0.2 \leq {R}_{1 o} / {f}_{1} \leq 0.8 ;$$
wherein R₁ₒ is a curvature radius of the object-side surface of the first lens; f₁ is a focal length of the first lens.

16. The optical system according to claim 14, wherein the optical system satisfies the following condition:
$$( {V}_{1} + {V}_{4} ) / 2 - {V}_{3} > 20 ;$$
wherein, V₁ is an Abbe number of the first lens; V₃ is an Abbe number of the third lens; V₄ is an Abbe number of the fourth lens.

17. The optical system according to claim 15, wherein the optical system satisfies the following condition:
$$1.2 < TTL / ImgH < 1.8 ;$$
wherein TTL is a total track length of the optical system; ImgH is a maximum imaging height of the optical system.

18. The optical system according to claim 15, wherein the optical system further satisfies:
$$\frac{{f}_{2}}{f} > 10 ;$$
wherein f₂ is a focal length of the second lens in the optical system; f is a focal length of the optical system.

19. An imaging device, wherein the imaging device comprises the optical system claimed as claim 15 and an image sensor; the image sensor is set on the image plane of the optical system.

20. An imaging device, wherein the electronic device comprises the imaging device claimed as claim 19.
